(19) United States
(12) Patent Application Publication
(10) Pub. No.: US 2019/0354368 A1
(43) Pub. Date: Nov. 21, 2019

(54) ARITHMETIC PROCESSING APPARATUS AND CONTROL METHOD FOR ARITHMETIC PROCESSING APPARATUS

(71) Applicant: FUJITSU LIMITED, Kawasaki-shi (JP)

(72) Inventor: Ryohei Okazaki, Kawasaki (JP)

(73) Assignee: FUJITSU LIMITED, Kawasaki-shi (JP)

(21) Appl. No.: 16/378,037

(22) Filed: Apr. 8, 2019

(30) Foreign Application Priority Data
May 15, 2018 (JP) 2018-093840

(51) Int. Cl. G06F 9/22; G06F 9/52; G06F 9/30

(52) U.S. Cl. CPC G06F 9/226; G06F 9/3005; G06F 9/522

(57) ABSTRACT

An arithmetic processing apparatus includes a processor. The processor determines whether or not a fetch instruction satisfies a barrier setting condition, when the fetch instruction satisfies the barrier setting condition, adds the fetch instruction into a barrier microinstruction to be subjected to a barrier control of a barrier attribute corresponding to a satisfied barrier setting condition, generates an execution instruction by decoding the fetch instruction, allocates the execution instruction and the barrier microinstruction to respective execution queue circuits, when a memory access instruction and the barrier microinstruction in an out-of-order different from the order of programs are input, executes the memory access instruction and the barrier microinstruction, when the barrier microinstruction is input, performs a control so that a memory access instruction after the barrier microinstruction is not speculatively executed to overtake the barrier microinstruction and a predetermined execution instruction corresponding to the barrier attribute before the barrier microinstruction.

### CROSS-REFERENCE TO RELATED APPLICATION

This application is based upon and claims the benefit of the prior Japanese Patent Application No. 2018-093840, filed on May 15, 2018, the entire contents of which are incorporated herein by reference.

### FIELD

The embodiments discussed herein are related to an arithmetic processing apparatus and a control method for an arithmetic processing apparatus.

### BACKGROUND

An arithmetic processing apparatus is a processor or a CPU (Central Processing Unit) chip. Hereinafter, the arithmetic processing apparatus will be referred to as a processor. The processor has various structural or control features in order to efficiently execute the instructions of programs. The features include, for example, a pipeline configuration in which a plurality of instructions are processed in parallel at the same time, a configuration that is executed from an instruction that is ready to be executed in an out-of-order without being based on the order (in-order) of the instructions on programs, and a configuration in which an instruction of a branch prediction destination is speculatively executed before the branch condition of a branch instruction is determined.

Meanwhile, the processor has a privileged mode or an OS mode (kernel mode) for executing an OS (Operating System) program in addition to a user mode for executing a user program. An instruction of the user mode is prohibited from accessing a protected memory area that can only be accessed in the privileged mode. When the user mode instruction tries to access the protected memory area, the processor detects an illegal memory access, and traps and cancels the execution of the instruction. Such a configuration prevents data in the protected memory area from being illegally accessed.

Related techniques are disclosed in, for example, Japanese Laid-open Patent Publication Nos. 2000-322257 and 2010-015298, and Jann Horn, “Reading privileged memory with a side-channel,” (online), (searched on May 9, 2018), Internet <https://googleprojectzero.blogspot.jp/2018/01/reading-privileged-memory-with-side.html?m=1>

### SUMMARY

According to an aspect of the embodiments, an arithmetic processing apparatus includes a processor. The processor determines whether or not a fetch instruction satisfies a barrier setting condition, when the fetch instruction satisfies the barrier setting condition, adds the fetch instruction into a barrier microinstruction to be subjected to a barrier control of a barrier attribute corresponding to a satisfied barrier setting condition, generates an execution instruction by decoding the fetch instruction, allocates the execution instruction and the barrier microinstruction to respective execution queue circuits, when a memory access instruction and the barrier microinstruction in an out-of-order different from the order of programs are input, executes the memory access instruction and the barrier microinstruction, when the barrier microinstruction is input, performs a control so that a memory access instruction after the barrier microinstruction is not speculatively executed to overtake the barrier microinstruction and a predetermined execution instruction corresponding to the barrier attribute before the barrier microinstruction.

The object and advantages of the invention will be realized and attained by means of the elements and combinations particularly pointed out in the claims. It is to be understood that both the foregoing general description and the following detailed description are exemplary and explanatory and are not restrictive of the invention, as claimed.

### BRIEF DESCRIPTION OF DRAWINGS

FIG. 1 is a view illustrating an example of vulnerability of a processor;

FIG. 2 is a view illustrating an example of a configuration of a processor according to an embodiment;

FIG. 3 is a view illustrating an example of a configuration a barrier setting circuit BA_SET and an instruction decoder I_DEC;

FIG. 4 is a flowchart illustrating an example of an operation of the barrier setting circuit;

FIG. 5 is a view illustrating an example of a configuration of a reservation station RSA and a primary data cache L1_DCACHE;

FIG. 6 is a view illustrating an outline of an order guarantee control (barrier control) in the processor related to a barrier microinstruction of a BBM attribute;

FIG. 7 is a flowchart of barrier control BC1 for a barrier microinstruction in RSA;

FIG. 8 is a flowchart of barrier control BC2 for an instruction other than the barrier microinstruction in RSA;

FIG. 9 is a view illustrating an example of a configuration of input queues of RSA and RSBR;

FIG. 10 is a view illustrating an example of a configuration of input queues of RSA and RSBR;

FIG. 11 is a view illustrating an example of a configuration of input queues of RSA and RSBR;

FIG. 12 is a view illustrating an example of a configuration of input queues of RSA and RSBR;

FIG. 13 is a view illustrating an outline of the order guarantee control (barrier control) in the processor related to a barrier microinstruction of an MBM attribute;

FIG. 14 is a flowchart of barrier control BC1_B for a barrier microinstruction in RSA;

FIG. 15 is a view illustrating an example of barrier control in RSA for Example_3 in which a barrier microinstruction is added after an instruction appended with a BBM attribute flag;

FIG. 16 is a view illustrating an example of barrier control in RSA for Example_3 in which a barrier microinstruction is added after an instruction appended with a BBM attribute flag;

FIG. 17 is a flowchart illustrating an example of control in a queue FP_QUE of a fetch port of a memory access control circuit;

FIG. 18 is a view illustrating an example of the queue FP_QUE of the fetch port;

FIG. 19 is a view illustrating an outline of order guarantee control (barrier control) in the processor related to a barrier microinstruction of an ABM attribute;

FIG. 20 is a flowchart of barrier control BC5 in the fetch port of the memory access control circuit;

FIG. 21 is a view for explaining the barrier control BC5 in the fetch port of the memory access control circuit for Example_4;

FIG. 22 is a view for explaining the barrier control BC5 in the fetch port of the memory access control circuit for Example_4;

FIG. 23 is a view illustrating an outline of the order guarantee control (barrier control) in the processor related to a barrier microinstruction of an ABA attribute flag;

FIG. 24 is a flowchart illustrating a barrier microinstruction (BA instruction) in an instruction decoder and barrier control BC6 for instructions before and after the barrier microinstruction;

FIG. 25 is a view for explaining the barrier control BC6 for an instruction string of Example_5;

FIG. 26 is a view for explaining the barrier control BC6 for an instruction string of Example_5;

FIG. 27 is a view for explaining the barrier control BC6 for an instruction string of Example_5.

FIG. 28 is a view illustrating an example of a configuration of a processor according to a second embodiment;

FIG. 29 is a view illustrating a schematic configuration of a barrier setting circuit BA_SET and an instruction decoder I_DEC according to the second embodiment;

FIG. 30 is a view illustrating an example of a configuration of the instruction decoder I_DEC;

FIG. 31 is a view illustrating an example of a detailed configuration of one slot PD1 of a pre-decoder, one slot PB0 of a pre-decoder buffer, and one slot D1 of a main decoder of the instruction decoder; and

FIG. 32 is a flowchart illustrating the operation of the pre-decoder and the pre-decoder buffer in the instruction buffer.

### DESCRIPTION OF EMBODIMENTS

There is a risk of reading secret data in a protected memory area before the branch condition of the branch instruction is determined, when a load instruction illegally added to the program is speculatively executed. Thereafter, it may be considered that the load instruction is speculatively executed with the secret data as an address.

Alternatively, there is a risk of reading secret data in a protected memory area by an illegal load instruction illegally added to the program before the illegal load instruction is executed, and detected by the processor so that a trap occurs. Thereafter, it may be considered that the load instruction is speculatively executed with the secret data as an address.

In the above cases, by the execution of the second load instruction, the data loaded in the cache line of the address of the secret data in the cache memory is registered. Then, after the branch condition of the branch instruction is determined or after the trap occurs, the secret data may be illegally acquired by measuring the latency by reading the data in the cache memory, and detecting an address with a shorter latency.

In order to avoid the vulnerability of the processor as described above, for example, it is necessary to suppress speculative execution of an illegal memory access instruction (load instruction). In addition, before the completion of the execution of the illegal memory access instruction (load instruction) and detection of the trap, it is necessary to suppress a subsequent memory access instruction (load instruction) from being speculatively executed.

However, speculatively executing a branch prediction destination instruction while the branch destination of the branch prediction destination instruction is undetermined or speculatively executing a next load instruction before the completion of processing of the load instruction is a means for improving the processing efficiency of the processor. Therefore, it is not desirable to uniformly suppress the speculative execution because the program processing efficiency of the processor may be deteriorated. In addition, it may not be a realistic solution to embed an additional code for suppressing the speculative execution in the existing program because embedding additional codes requires substantial man-hours.

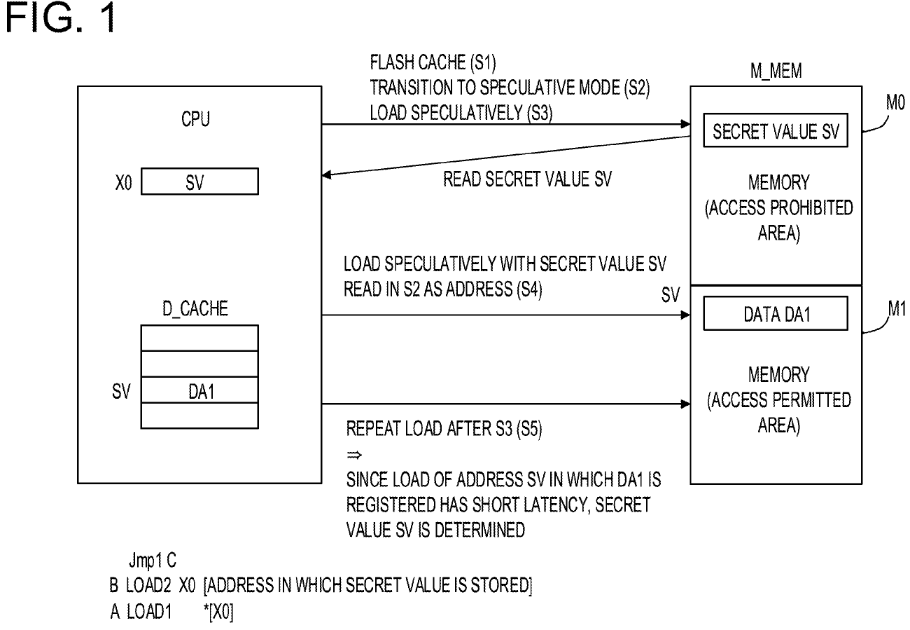

FIG. 1 is a view for explaining an example of vulnerability of a processor. FIG. 1 illustrates a processor CPU and a main memory M_MEM. FIG. 1 further illustrates an example of an instruction string to be executed by the processor CPU.

An example of the instruction string is a first example of an illegal program, and the contents of each instruction are as follows. JMP C // branch instruction to branch to branch destination A // B LOAD2 X0 [address of secret value storage] // load to address in which secret value is stored and store secret value in register X0 // A LOAD1 * [X0] // load to address of register X0 //

An illegal load instruction “B LOAD2” is added to the above-indicated instruction string. Therefore, the illegal program first clears a cache memory (S1) and transitions to a privileged mode (OS mode) (S2). Then, the processor executes a branch instruction JMP C in the privileged mode, but speculatively executes a load instruction LOAD2 of a branch prediction destination B before a branch destination C of the branch instruction is determined (S3). The branch prediction destination B is illegally registered as branch prediction information, but it is assumed that the correct branch destination of the branch instruction is C.

When the processor speculatively executes the load instruction LOAD2 of this illegal branch prediction destination B (S3), the processor reads a secret value SV in a protected memory area M0 that is permitted to be accessed only in the privileged mode, and stores the secret value SV in a register X0. Further, when the processor speculatively executes the next load instruction A LOAD1, the processor reads data DA1 in a memory area M1 that is permitted to be accessed in the user mode with the secret value in the register X0 as an address (S4). As a result, the data DA1 is registered in the address SV in a cache memory CACHE in the processor.

Thereafter, when the processor repeats a load instruction (not illustrated) while changing the address, the access latency of the load instruction to the address SV in which the data DA1 is registered becomes shorter than those of the other addresses, and thus, the contents of the address SV may be recognized. As a result, the security of the secret value SV is degraded.

When the execution of the branch instruction JMP C is completed after the two load instructions LOAD2 and LOAD1 are speculatively executed, it is determined that the branch prediction destination B was a branch prediction miss, and the state of a speculatively-executed load instruction of a pipeline circuit in the processor is cleared. However, since the cache memory is not cleared, it is possible to acquire the secret value SV based on the latency of the cache memory.

In this manner, the execution of the load instructions LOAD2 and LOAD1 of the illegal branch prediction destination before the branch destination of the branch instruction JMP is determined is one of the causes of processor vulnerability.

A second instruction string that causes vulnerability of a second processor is as follows. LOAD1 X0 [privileged area] LOAD2 X1 [X0] LOAD1 is a load instruction to store a secret value of the address of the privilege area in the register X0, and LOAD2 is a load instruction to store in a register X1 a value in a memory with a value (secret value) stored in the register X0 as an address. It is assumed that both of the load instructions are executed in the user mode.

In this case, since the first load instruction LOAD1 accesses the protected memory area (privileged area) in the execution in the user mode, a trap occurs during the execution and the pipeline circuit in the processor is cleared. However, when the second load instruction LOAD2 is speculatively executed at a timing when the trap has not yet occurred before the execution of the first load instruction LOAD1 is completed, data in an area with the secret value in the register X0 as an address is registered in the cache. As in the example of FIG. 1, when the processor repeats the load instruction while changing the address, the access latency of the load instruction to the address of the secret value becomes shorter than those of the other addresses, and thus, the secret value of the address may be recognized.

In the instruction string, it is considered that the speculative execution of the second load instruction LOAD2 after the execution of the first load instruction LOAD1 is completed and the trap determination is completed is the cause of the processor vulnerability. In order to eliminate such vulnerability, the order guarantee control may be performed so that the next load instruction LOAD2 is not executed until the execution of the first load instruction LOAD1 is completed.

In the above two examples, the speculative execution of the instruction causing the processor vulnerability includes (1) a speculative execution of an instruction after a barrier instruction at a stage where the branch destination of the branch instruction before the barrier instruction is not determined and (2) a speculative execution of an instruction after the barrier instruction at a stage where the barrier instruction is trapped and the canceling process is not completed when the barrier instruction executing a memory access accesses an access-prohibited area in a memory. In addition to the above examples, there is a case where a speculative execution of an instruction that occurs under specific circumstances may cause the processor vulnerability.

### Embodiments

<Processor Configuration>

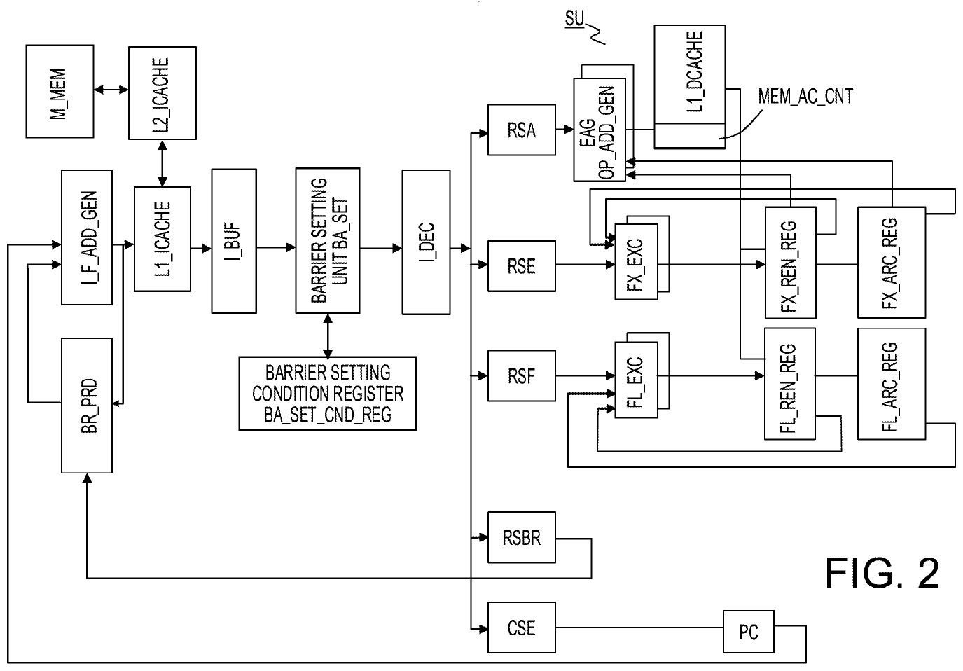

FIG. 2 is a view illustrating an example of a configuration of a processor according to an embodiment. The processor illustrated in FIG. 2 includes a storage unit SU, one or more fixed point arithmetic circuits FX_EXC, and one or more floating point arithmetic circuits FL_EXC.

The storage unit SU includes an operand address generation circuit OP_ADD_GEN including an addition/subtraction circuit for address calculation, and a primary data cache L1_DCACHE. The primary data cache has a memory access control circuit MEM_AC_CNT for controlling an access to a main memory when a cache miss occurs, in addition to a cache memory.

The fixed point arithmetic circuit FX_EXC and the floating point arithmetic circuit FL_EXC have, for example, respective addition/subtraction circuits, logic operation circuits, and multiplication circuits. The floating point arithmetic circuit has, for example, a number of arithmetic circuits corresponding to the SIMD (Single Instruction Multiple Data) width, so that SIMD calculation may be performed.

The overall configuration of the processor will be described below along a processing flow of instructions. An instruction fetch address generation circuit I_F_ADD_GEN generates a fetch address, and temporarily stores in an instruction buffer I_BUF a fetch instruction fetched from a primary instruction cache L1_ICACHE in the order (in-order) of execution in a program. Then, an instruction decoder I_DEC inputs and decodes the fetch instruction in the instruction buffer in the in-order, so as to generate an executable instruction (execution instruction) to which information necessary for execution is added.

In the embodiment, the processor includes a barrier setting circuit BA_SET between the instruction buffer IBUF and the instruction decoder IDEC. The barrier setting circuit BA_SET refers to a barrier setting condition set in a barrier setting condition register BA_SET_CND_REG to determine whether or not the fetch instruction corresponds to (i.e., matches) the barrier setting condition. When the fetch instruction corresponds to the barrier setting condition, the barrier setting circuit BA_SET performs a barrier setting such as adding a barrier instruction after the fetch instruction corresponding to the barrier determination condition. Then, the barrier setting circuit BA_SET outputs the fetch instruction and the barrier instruction to the instruction decoder I_DEC. The barrier setting circuit BA_SET may be contained in the instruction decoder I_DEC. The barrier setting will be described in more detail later.

The above barrier instruction is a microinstruction (micro operation (μop)) which is a unit of processing by hardware. Among instructions prescribed by ISA (Instruction Set Architecture), simple instructions are executed by hardware without being decomposed in correspondence to one microinstruction. Complex instructions are decomposed into a plurality of microinstructions which are executed by hardware. The barrier instruction is executed by hardware without being decomposed in correspondence to a microinstruction. Hereinafter, the barrier instruction will be referred to as a barrier microinstruction or a barrier uop (“u” means the Greek letter p).

Next, the execution instruction generated in the instruction decoder is queued and stored in a storage having a queue structure called a reservation station in-order. The reservation station is an execution queue for storing the execution instructions in a queue and is provided for each arithmetic circuit that executes an instruction. The reservation station includes, for example, an RSA (Reservation Station for Address Generation) provided in the storage unit SU including the operand address generation circuit OP_ADD_GEN and the L1 data cache L1_DCAHCE, an RSE (Reservation Station for Execution) provided in the fixed point arithmetic circuit FX_EXC), and an RSF (Reservation Station for Floating Point) provided in the floating point arithmetic circuit FL_EXC. The reservation station further includes an RSBR (Reservation Station for Branch) corresponding to a branch prediction unit BR_PRD.

Hereinafter, the reservation station will be appropriately abbreviated and referred to as an RS.

Then, based on a determination as to whether or not the instruction execution condition is satisfied, such as a determination as to whether or not an input operand necessary for instruction execution is readable out from a general-purpose register file by completion of arithmetic processing of the previous instruction (whether the read-after-write (RAW) constraint is satisfied) or a determination as to whether the circuit resources of an arithmetic circuit is usable, the execution instruction queued in each RS is issued to and executed in an arithmetic circuit in a random order (out-of-order).

Meanwhile, the instruction decoder I_DEC allocates an instruction identification (IID) to an execution instruction generated by decoding the fetch instruction in the order of execution in the program, and transmits the execution instruction to a commit stack entry (CSE) in an in-order. The CSE has a storage of a queue structure in which the transmitted execution instruction is stored in an in-order, and an instruction commit processing unit that performs commit processing (completion processing) of each instruction in response to an instruction processing completion report from the pipeline circuit of the arithmetic circuit based on information in the queue. Therefore, the CSE is a completion processing circuit that performs the instruction completion processing.

The execution instruction is stored in the queue in the CSE in an in-order, and the CSE waits for the instruction processing completion report from each arithmetic circuit. As described above, the execution instruction is transmitted in an out-of-order from each RS to the arithmetic circuit and is executed by the arithmetic circuit. Thereafter, when the instruction processing completion report is sent to the CSE from the arithmetic circuit, the instruction commit processing unit of the CSE completes in an in-order the processing of an execution instruction corresponding to the processing completion report among instructions waiting for the processing completion report stored in the queue and updates the circuit resources such as a register.

The processor further includes an architectural register file (or a general register file) ARC_REG accessible from software, and a renaming register file REN_REG for temporarily storing the arithmetic result by the arithmetic circuit. Each register file has a plurality of registers. In addition, each register file is provided to correspond to each of the fixed point arithmetic circuit and the floating point arithmetic circuit.

In order to enable the out-of-order execution of the execution instruction, the renaming register file temporarily stores the arithmetic result, and in the completion processing of the execution instruction, the arithmetic result stored in the renaming register is stored in a register in the architectural register file, and the register in the renaming register file is opened. In addition, the CSE increments a program counter PC in the completion processing.

The branch instruction queued in the branch processing RSBR is branch-predicted by the branch prediction unit BR_PRD, and the instruction fetch address generation circuit I_F_ADD_GEN generates a branch destination address based on the branch prediction result. As a result, an instruction based on the branch prediction is read out from the instruction cache and speculatively executed by the arithmetic circuit via the instruction buffer and the instruction decoder. The RSBR executes a branch instruction in an in-order. However, before a branch destination of the branch instruction is determined, the branch destination is predicted and an instruction of the predicted branch destination is speculatively executed. When the branch prediction is correct, the processing efficiency increases. Meanwhile, when the branch prediction is incorrect, the speculatively executed instruction is canceled and the processing efficiency decreases. The processing efficiency is improved by increasing the accuracy of branch prediction.

In addition, the processor has a secondary instruction cache L2_CACHE which accesses the main memory M_MEM via a memory access controller (not illustrated). Likewise, the primary data cache L1_DCACHE has a memory access control circuit (not illustrated) in its cache control circuit. The memory access control circuit is connected to a secondary data cache (not illustrated). When a cache miss occurs in the primary data cache, the memory access control circuit controls a memory access to the main memory M_MEM. The memory access control circuit processes a memory access instruction in an in-order.

<Instruction Decoder>

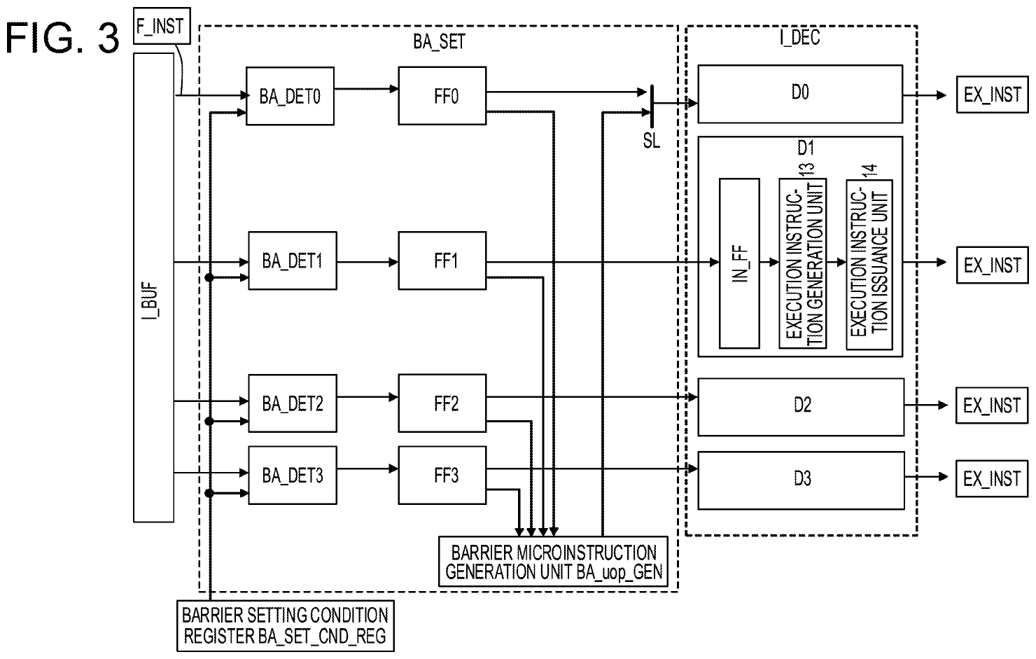

FIG. 3 is a view illustrating an example of a configuration of the barrier setting circuit BA_SET and the instruction decoder I_DEC. The barrier setting circuit and the instruction decoder may be combined into a barrier setting/instruction decoder. As described above, the barrier setting circuit BA_SET determines whether or not the fetch instruction corresponds to the barrier setting condition, and adds a barrier microinstruction after the corresponding fetch instruction. The instruction decoder I_DEC decodes a fetch instruction F_INST transferred from the instruction buffer I_BUF to generate an execution instruction EX_INST. In the embodiment, for example, the instruction decoder I_DEC has four slot decoders D0 to D3 in order to increase the processing efficiency of the instruction decoder. Each of the slot decoders D0 to D3 includes an input flip-flop IN_FF for inputting a fetch instruction, an execution instruction generation circuit 13 for decoding the fetch instruction to generate an execution instruction, and an execution instruction issuance circuit 14 that issues the execution instruction to the reservation station of the arithmetic circuit. The barrier setting/instruction decoder has both of the configuration of the barrier setting circuit and the configuration of the instruction decoder.

The execution instruction EX_INST is an instruction including a decoding result for making an operation code of the fetched instruction F_INST executable. For example, the execution instruction EX_INST is an instruction including information necessary for arithmetic, such as which reservation station is used, which arithmetic circuit is used, and which data is used for an operand. The execution instruction generation circuit 13 decodes the fetched instruction operation code to obtain information necessary for arithmetic execution and generate an execution instruction.

<Barrier Setting Circuit>

As illustrated in FIGS. 2 and 3, in the embodiment, the barrier setting circuit BA_SET is provided between the instruction buffer I_BUF and the instruction decoder I_DEC. The barrier setting circuit BA_SET has a four-slot configuration similarly corresponding to the four-slot instruction decoder I_DEC. The barrier setting circuit BA_SET includes barrier determination circuits BA_DET0 to BA_DET3 for determining whether or not the fetch instruction corresponds to (or matches) the barrier setting condition and appending a barrier attribute to the fetch instruction when the fetch instruction corresponds to the barrier setting information, flip-flops FF0 to FF3 for temporarily latching the fetch instruction appended with the barrier attribute, and a barrier microinstruction generation circuit BA_UOP_GEN for adding a barrier microinstruction after the fetch instruction appended with the barrier attribute. The barrier determination circuits and the flip-flops also have a 4-slot configuration in accordance with the 4-slot instruction decoder I_DEC. However, when the instruction decoder has a one-slot configuration, the barrier determination circuits may also have a one-slot configuration.

Each barrier determination circuit BA_DET determines whether or not the fetch instruction input in an in-order from the instruction buffer corresponds to the barrier setting condition set in the barrier setting condition register BA_SET_CND_REG. The barrier setting condition set in the barrier setting condition register is, for example, an operation code of an instruction corresponding to the barrier setting condition or, conversely, an operation code masked from the barrier setting condition. In this case, the barrier determination circuit determines whether or not the fetch instruction matches the operation code corresponding to the barrier setting condition or whether or not the fetch instruction matches the masked operation code.

The barrier setting condition is, for example, an exceptional level such as a privileged mode having a higher level than the normal mode (user mode), a contents ID specifying a user program (user process), or the like. In this case, the barrier determination circuit determines whether the fetch instruction is an instruction of the exceptional level or an instruction of the contents ID.

The barrier setting condition set in the barrier setting condition register is different for each order guarantee attribute indicating the type of guarantee of the execution order of instructions. When the fetch instruction corresponds to the above-described barrier determination condition, the barrier determination circuit appends the order guarantee attribute (or barrier attribute) corresponding to the corresponding barrier determination condition to the fetch instruction. Appending the barrier attribute means adding a barrier attribute flag to the fetch instruction. Then, the barrier determination circuit transfers an instruction appended with the barrier attribute flag to the flip-flops FF0 to FF3. The barrier microinstruction generation circuit adds a barrier microinstruction corresponding to the barrier attribute after the barrier attribute flag-appended instruction latched in the flip-flops FF0 to FF3. A determination process by the barrier determination circuit will be described later.

Briefly speaking, the execution order guarantee of instructions is such that a barrier microinstruction corresponding to the order guarantee attribute is added after the order guarantee attribute-appended instruction, and the added barrier microinstruction is executed in a form or order conforming to the order guarantee corresponding to the order guarantee attribute (barrier attribute) in the RS (RSA) or the storage unit SU, thereby suppressing the speculative execution of instructions. Even for the processing of instructions in an in-order by the instruction decoder, the constraints on predetermined order guarantee are imposed to suppress the speculative execution of instructions.

As described above, the barrier determination circuit determines whether or not the four in-order fetch instructions input from the memory buffer correspond to the barrier setting condition (whether or not the corresponding instructions are order guarantee-targeted instructions). When it is determined that none of the four fetch instructions correspond to the barrier setting condition, the fetch instructions are input, as they are, to the four slots of the instruction decoder I_DEC in parallel.

When it is determined in the barrier determination circuit that any one of the four fetch instructions corresponds to the barrier setting condition, a barrier attribute flag is appended to the fetch instruction. Then, the barrier microinstruction generation circuit generates a barrier microinstruction after the barrier attribute flag-appended fetch instruction.

As a result, the barrier setting circuit BA_SET outputs the barrier microinstruction in addition to the four fetch instructions input from the instruction buffer. In that case, in the first clock cycle, a fetch instruction before the barrier microinstruction is input from the flip-flops to the corresponding slot of the instruction decoder I_DEC, and in the next clock cycle, the barrier microinstruction is input to the slot D0 of the instruction decoder via a selector SL. Then, in the next clock cycle, a fetch instruction after the barrier microinstruction is input to the corresponding slot of the instruction decoder. The barrier microinstruction is a barrier instruction for barrier control, and accordingly, the order guarantee control is imposed in, for example, RSA.

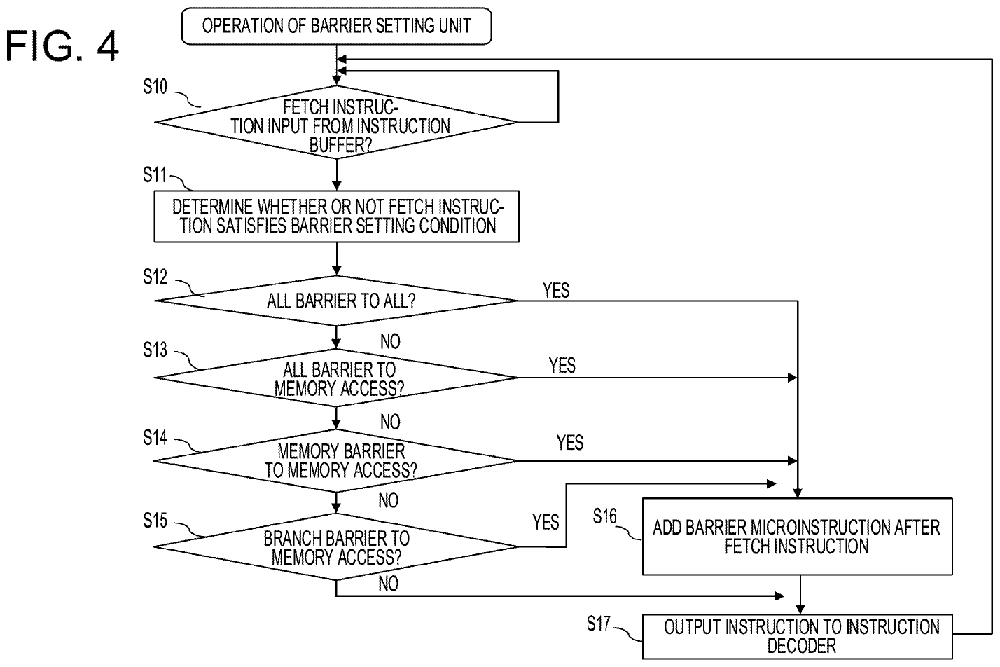

FIG. 4 is a flowchart illustrating an example of an operation of the barrier setting circuit. In the barrier setting circuit BA_SET, when the four in-order fetch instructions are input from the instruction buffer (S10), the barrier determination circuit BA_DET determines whether or not the fetch instructions correspond to (or match) the barrier setting condition set in the barrier setting condition register BA_SET_CND_REG (S11). As described above, the barrier setting condition is set for each of a plurality of order guarantee attributes (barrier attributes). The barrier determination circuit may individually determine the barrier setting conditions of the plurality of order guarantee attributes or may preferentially determine an order guarantee attribute having a stronger order regulation.

In the embodiment, a stronger order guarantee attribute is preferentially set. The order guarantee attribute of this embodiment is of the following four types in the order of weaker order regulation, that is, Branch Barrier to memory access (BBM): Barrier attribute of branch instruction versus memory access instruction, Memory Barrier to memory access (NBM): Barrier attribute of memory access instruction versus memory access instruction, All Barrier to memory access (ABM): Barrier attribute of all instructions versus memory access instruction, and All Barrier to All (ABA): Barrier attribute of all instructions versus all instructions. The order guarantee contents of the above four order guarantee attributes (barrier attributes) are as follows. This order guarantee may be already defined in the ISA (Instruction Set Architecture) adopted by the processor's hardware or may be uniquely defined by the hardware.

In the case of Branch Barrier to memory access (BBM), the processor performs the order guarantee control (or barrier control) to guarantee that a memory access instruction after a barrier microinstruction of this barrier attribute is not speculatively executed to overtake a branch instruction before the barrier microinstruction.

In the case of Memory Barrier to memory access (MBM), the processor performs order guarantee control to guarantee that a memory access instruction after a barrier microinstruction of the barrier attribute is not speculatively executed to overtake a memory access instruction before the barrier microinstruction.

In the case of All barrier to memory access (ABM), the processor performs order guarantee control to guarantee that a memory access instruction after a barrier microinstruction of this barrier attribute is not speculatively executed to overtake all instructions before the barrier microinstruction.

In the case of All barrier to All access (ABA), the processor performs order guarantee control to guarantee that all instructions after a barrier microinstruction of this barrier attribute is not speculatively executed to overtake all instructions before the barrier microinstruction.

Since the instruction execution order guarantee as described above is imposed on the barrier microinstruction, ABA is the strongest order regulation, and the order regulation becomes weaker in the order of ABM, MBM, and BBM.

As illustrated in FIG. 4, when it is determined that the fetch instruction corresponds to the barrier setting condition of All Barrier All (ABA) (“YES” in S12), the barrier setting circuit adds a barrier microinstruction of the barrier attribute of All Barrier to All (ABA) after the fetch instruction corresponding to the barrier setting condition, regardless of whether or not the fetch instruction corresponds to the barrier setting conditions of the other barrier attributes (S16).

When it is determined that the fetch instruction does not correspond to the barrier setting condition of ABA (“NO” in S12) and corresponds to the barrier setting condition of All Barrier to memory access (ABM) (“YES” in S13), the barrier setting circuit adds a barrier microinstruction of the barrier attribute of All Barrier to memory access (ABM) after the fetch instruction corresponding to the barrier setting condition, regardless of whether or not the fetch instruction corresponds to the barrier setting conditions of the remaining barrier attributes (S16).

When it is determined that the fetch instruction does not correspond to the barrier setting condition of ABM (“NO” in S13) and corresponds to the barrier setting condition of Memory Barrier to memory access (MBM) (“YES” in S14), the barrier setting circuit adds a barrier microinstruction of the barrier attribute of Memory Barrier to memory access (MBM) after the fetch instruction corresponding to the barrier setting condition, regardless of whether or not the fetch instruction corresponds to the barrier setting conditions of the remaining barrier attributes (S16).

Similarly, when it is determined that the fetch instruction does not correspond to the barrier setting condition of MBM (“NO” in S14) and corresponds to the barrier setting condition of Branch Barrier to memory access (BBM) (“YES” in S15), the barrier setting circuit adds a barrier microinstruction of the barrier attribute of Branch Barrier to memory access (BBM) after the fetch instruction corresponding to the barrier setting condition (S16).

When it is determined that the fetch instruction does not correspond to any barrier setting conditions of the barrier attributes (“NO” in S15), the barrier setting circuit does not add a barrier microinstruction to the fetch instruction.

Then, the barrier setting circuit outputs the fetch instruction and the barrier microinstruction to the instruction decoder I_DEC (S17).

Then, the barrier microinstruction is constrained by the order control of the order guarantee attributes (barrier attributes) corresponding the barrier attribute BBM, MBM, ABM, and ABA of the corresponding barrier setting conditions.

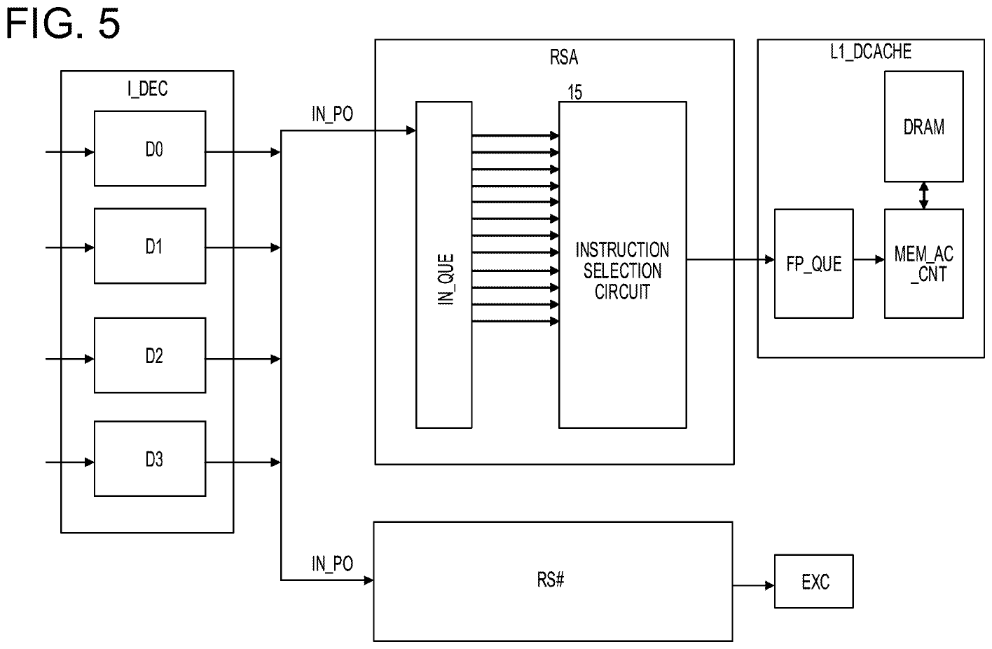

FIG. 5 is a view illustrating an example of a configuration of the reservation station RSA and the primary data cache L1_DCACHE. The reservation station RSA has an input port IN_PO to which an execution instruction issued by the instruction decoder I_DEC is input, and an input queue IN_QUE for storing execution instructions input from the input port IN_PO. A memory access instruction is input to the RSA. Further, the RSA has an instruction selection circuit 15 that selects the oldest instruction out of instructions prepared for execution among the instructions stored in the input queue and issues the selected instruction to the primary data cache. As a result, the instructions stored in the input queue are issued to the primary data cache in an out-of-order.

A reservation station RS# provided in the other arithmetic circuit EXC has the same configuration and performs the same instruction issuance control.

The memory access instruction issued from the RSA is subjected to the necessary address calculation by the operand address generation circuit (see FIG. 2) and input to a queue FP_QUE in a fetch port in the primary data cache L1_DCACHE together with an access destination address. The memory access instruction entered into the fetch port queue is issued to the memory access control circuit MEM_AC_CNT. Then, the memory access control circuit makes a cache determination as to whether or not the data of the access address has been registered in a data RAM (D_RAM) which is a cache memory. When a cache hit occurs, the memory access control circuit reads the data in the cache memory and stores the data in the general purpose register. When a cache miss occurs, the memory access control circuit issues a memory access request to the secondary data cache or the main memory. The data acquired by the memory access is registered in the L1 data cache.

The barrier microinstructions of the barrier attributes BBM, MBM, and ABM are queued in the RSA of the reservation station and their issuance is controlled in accordance with the order guarantee of instruction execution in the RSA. With this issuance control, the RSA issues the barrier microinstruction and its related instruction not in an out-of-order, but in an in-order which is an order based on the order guarantee of the barrier attribute of the barrier microinstruction. Further, if necessary, the fetch port queue FP_QUE in the primary data cache L1_DCACHE waits for the completion of a memory access instruction before the memory access instruction issued from the RSA and performs the memory access instruction issuance control so as to execute a next memory access instruction.

However, the barrier microinstruction of the All Barrier to All (ABA) attribute performs the issuance control according to the order guarantee of the ABA attribute in the instruction decoder I_DEC between the barrier microinstruction and instructions before and after the barrier microinstruction.

Hereinafter, a control on how to guarantee the order of instructions of the four kinds of barrier attributes BBM, MBM, ABM and ABA will be described.

<Branch Barrier to Memory Access (BBM)>

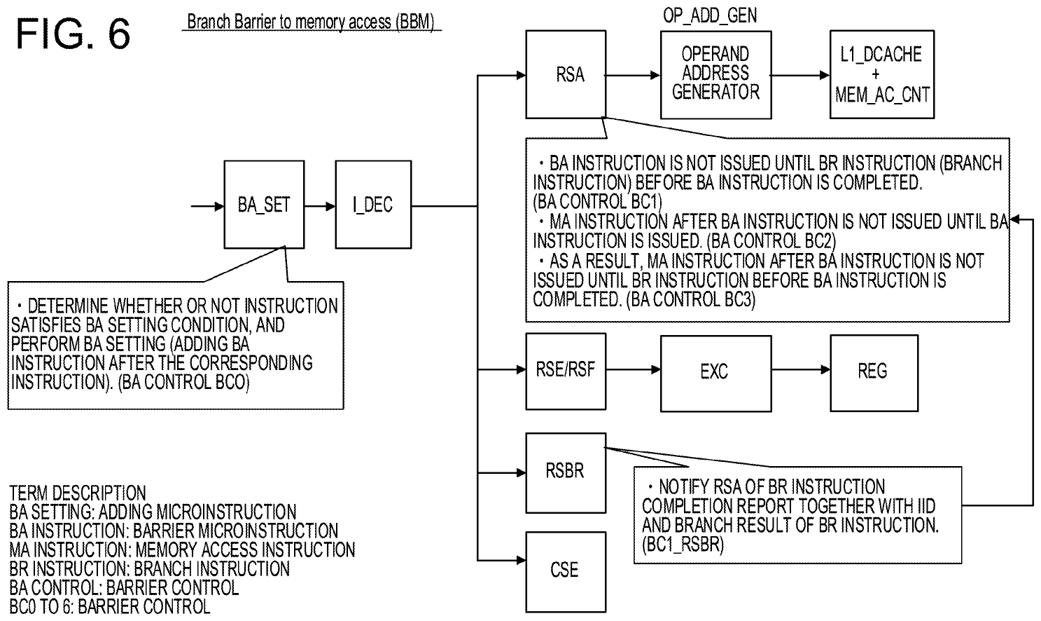

FIG. 6 is a view illustrating an outline of the order guarantee control (barrier control) in the processor related to a barrier microinstruction of the BBM attribute. First, as described above, the barrier setting circuit BA_SET determines whether or not the fetch instruction input from the instruction buffer corresponds to the barrier setting condition of BBM. When the fetch instruction corresponds to the barrier setting condition of BBM, the barrier setting circuit BA_SET performs barrier setting to add a barrier microinstruction after the corresponding instruction (barrier control BA0).

In the case of the BBM attribute, the processor performs the order guarantee control to guarantee that a memory access instruction after a barrier microinstruction of the barrier attribute is not speculatively executed to overtake a branch instruction before the barrier microinstruction. For the order guarantee control, when a barrier microinstruction is included in an execution instruction input from the instruction decoder I_DEC, the RSA firstly does not issue the barrier microinstruction until the branch instruction before the barrier microinstruction is completed (BC1), and secondly does not issue a memory access instruction after the barrier microinstruction until the barrier microinstruction is issued (BC2). As a result, the RSA does not issue a memory access instruction after the barrier microinstruction until the execution of the branch instruction before the barrier microinstruction is completed (BC3). In brief, the RSA performs the first barrier control BC1 and the second barrier control BC2 so as not to issue a memory access instruction after the barrier microinstruction until the execution of the branch instruction before the barrier microinstruction is completed (BC3). The barrier control BC3 may be performed as a control other than the first and second barrier controls BC1 and BC2.

Further, for the order guarantee control, the branch instruction RS (RSBR) notifies the commit stack entry CSE and the RSA of a branch instruction processing completion report together with an instruction ID (IID) of the branch instruction and a branch result (BC1_CSE). In response to the branch instruction processing completion report (with IID) from the RSBR, the CSE performs a branch instruction completion processing (commit processing) in an in-order. The RSBR processes branch instructions in an in-order. As a result, the branch instruction completion processing is performed in an in-order between branch instructions. Then, similarly to the notification to the CSE, after the branch instruction completion processing, the RSBR notifies the RSA of a branch instruction completion report together with the instruction ID (IID) of the branch instruction and the branch result. The RSA interlocks the barrier microinstruction to prohibit an issuance of the barrier microinstruction and stores an IID of a branch instruction immediately before the barrier microinstruction. Then, upon receiving the branch instruction completion report from the RSBR, the RSA determines whether or not the barrier microinstruction matches the IID of the branch instruction immediately before the barrier microinstruction. When the barrier microinstruction matches the IID of the branch instruction immediately before the barrier microinstruction, the RSA issues the barrier microinstruction to the L1 data cache L1_DCACHE (BC1).

Hereinafter, the above barrier control will be described by way of specific examples.

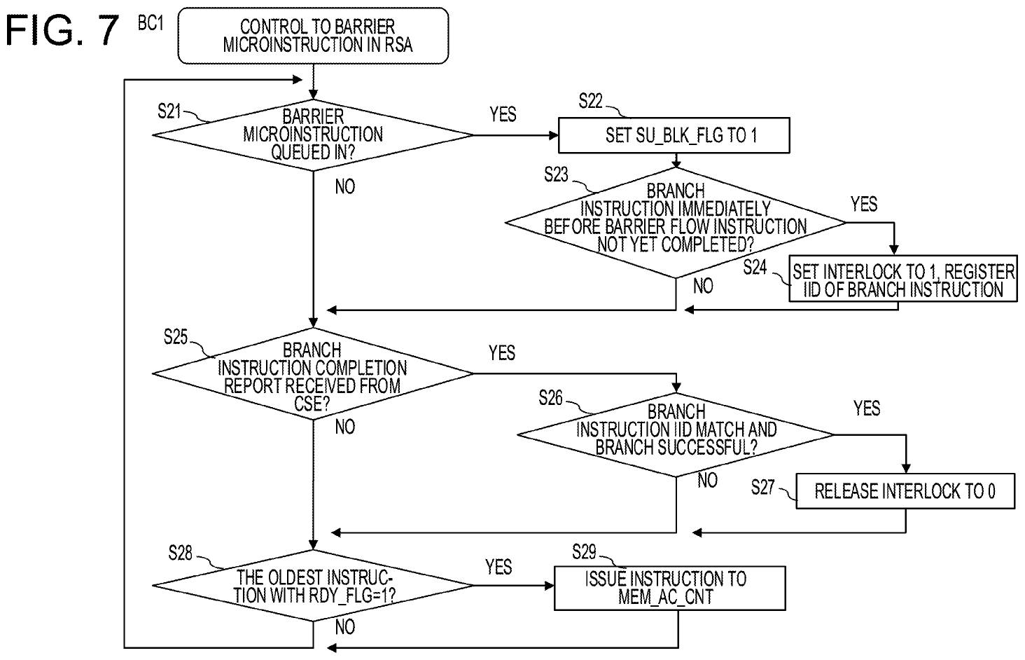

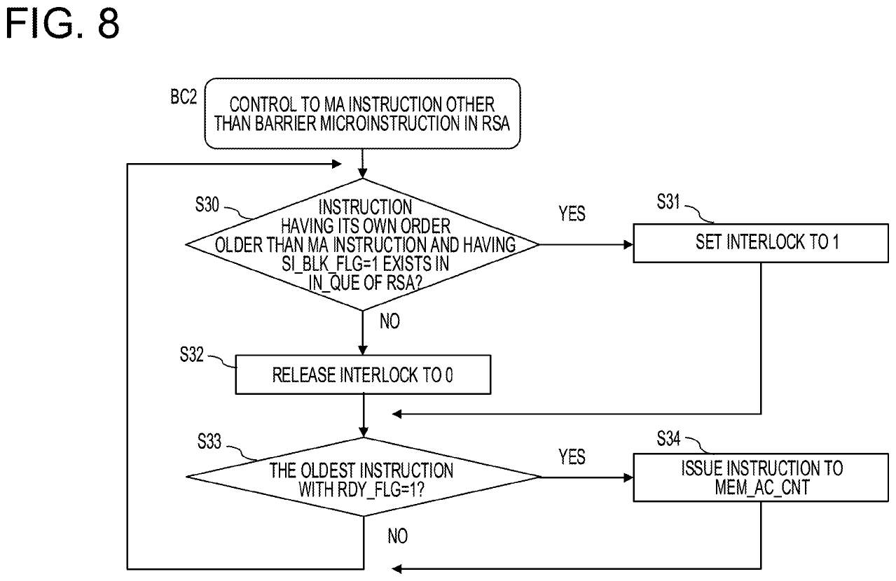

FIG. 7 is a flowchart of the barrier control BC1 for the barrier microinstruction in the RSA. FIG. 8 is a flowchart of the barrier control BC2 for instructions other than the barrier microinstruction in the RSA. The barrier controls BC1, BC2, and BC3 in the RSA will be described by way of two specific examples with reference to these flowcharts.

### Example_1: In Case where an Instruction Appended with a Barrier Attribute Flag is a Branch Instruction

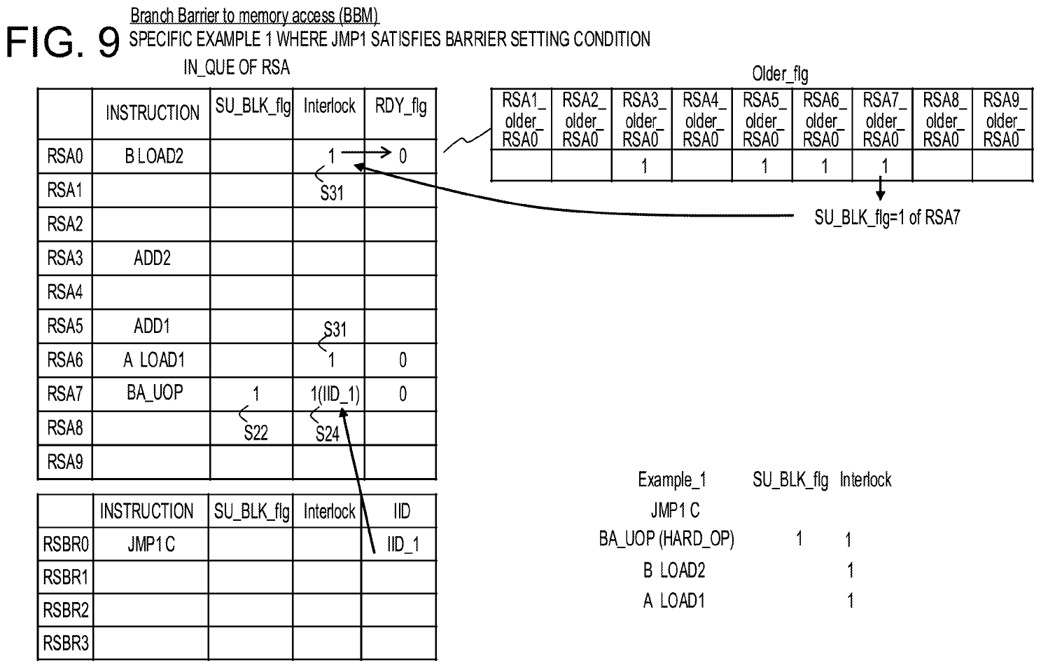

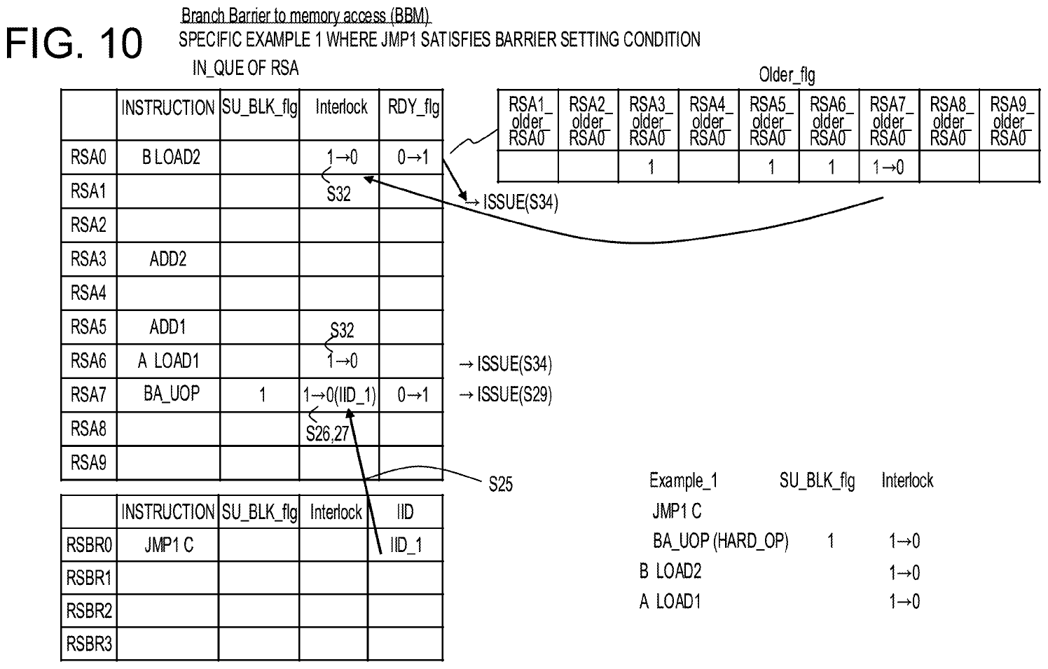

FIGS. 9 and 10 are views illustrating an example of a configuration of input queues of RSA and RSBR. FIG. 9 illustrates an instruction string having a branch instruction JMP1 C and two load instructions B LOAD2 and A LOAD1 illustrated in FIG. 1 as Example_1. In Example_1, the branch instruction JMP1 C corresponds to the BBM attribute and is appended with a barrier attribute flag. Therefore, the barrier setting circuit BA_SET adds a barrier microinstruction BA_UOP and outputs the branch instruction JMP1 C, the barrier microinstruction BA_UOP, and the memory access instructions B LOAD2 and B LOAD1 to the instruction decoder I_DEC.

The input queue IN_QUE of the RSA in FIG. 9 queues instructions issued in-order by the instruction decoder to ten entries RSA0 to RSA9. Since instructions are issued in an out-of-order from the input queue IN_QUE, the instructions queued in the input queue are not necessarily stored in the order of the entries RSA0 to RSA9. The barrier microinstruction BA_UOP and the two load instructions B LOAD2 and A LAOD1 of the instruction string are stored in the input queue of the RSA. Addition instructions ADD1 and ADD2 are, for example, instructions before the branch instruction JMP1 C and are executed by the operand address generation circuit, with no particular relation to the barrier control.

The input queue IN_QUE of the RSA appends to the queued instructions, for example, a storage unit block flag SU_BLK_flg for prohibiting issuance to a storage unit (L1 data cache), an interlock flag Interlock for prohibiting issuance from the RSA, and a ready flag RDY_flg indicating that the issuance from the RSA has been ready for. The ready flag is a flag indicating a state where an instruction can be issued from the RSA. In addition to an interlock issuance-prohibited state, the condition of the issuable state (ready state) is that the read-after-write is solved, etc. In addition, the RSA issues the oldest instruction whose ready flag is in the issuable state “1.”

Further, the input queue IN_QUE associates each of the queued instructions with an order flag Older_flg indicating whether or not an instruction older than the queued instruction (in front of the queued instruction) exists in another entry. In FIG. 9, an older flag Older_fig having a flag “1” is illustrated in the entries RSA3, 5, 6 and 7 of an instruction earlier (older) than the load instruction B LOAD2 of the entry RSA0. Other instructions are associated with an order flag, but are not illustrated in FIG. 9.

The barrier microinstruction BA_UOP which is a barrier instruction is queued in, and the RSA generates an entry thereof in the input queue (S21 in FIG. 7). The RSA generates an entry in the barrier microinstruction with a storage unit block flag (SU block flag) as SU_BLK_flg=1. Then, since the branch instruction JMP1 C immediately before the barrier microinstruction BA_UOP has not yet been completed (“YES” in S23), the RSA sets the interlock to Interlock=1, stores the IID of the branch instruction JMP1 C (S24), and suppresses issuance until the branch instruction JMP1 C is completed. As described above, since the CSE completes processing in an in-order between branch instructions, the completion of the branch instruction immediately before the barrier microinstruction signifies that all branch instructions before that have also been completed. Therefore, by monitoring that the branch instruction immediately before the barrier microinstruction has been completed, it is possible to detect the completion of all the branch instructions before the barrier microinstruction. When the interlock is set to Interlock=1, the ready flag RDY_fig is set to “0” which is not the issuance ready state.

Meanwhile, in FIG. 8, the RSA determines whether or not an instruction having its own order older than (in front of) the memory access instructions B LOAD2 and A LOAD1 after the barrier microinstruction BA_UOP and having SU_BLK_flg=1 exists in the input queue IN_QUE (S30). When the determination result is yes (“YES” in S30), the RSA sets the interlocks of these memory access instructions B LOAD2 and A LOAD1 to Interlock=1 (S31). By the Interlock=1, the ready flag becomes RDY_flg=0, and the memory access instruction after these barrier microinstructions cannot be issued from the RSA.

Next, transition is made to the input queue state of FIG. 10. In FIG. 7, when the branch instruction JMP1 C has been completed with successful branch prediction, the RSA receives from the RSBR a report that the IID of JMP1 C has been completed with the successful branch prediction (“YES” in S25). Then, the RSA detects that the IID of the processing completion report matches the cause IID of the interlock of the entry of the barrier microinstruction BA_UOP (“YES” in S26), and releases the interlock of the barrier microinstruction BA_UOP to Interlock=0 (S27). Thereafter, the RSA detects that the barrier microinstruction is the oldest instruction with the ready flag RDY_flg=1 (“YES” in S28) and issues the barrier microinstruction to the memory access control circuit MEM_AC_CNT of the L1 data cache (S29). Incidentally, the barrier microinstruction is a kind of dummy instruction, a memory access by the memory access control circuit is not executed, and the program counter PC is not updated by the completion processing of the barrier microinstruction.

Since the barrier microinstruction disappears from the input queue when the barrier microinstruction is issued from the RSA, the older flag Older_flg of the entry of each RSA is also updated, and the interlocks of the memory access instructions B LOAD2 and A LOAD1 are released to Interlock=0 (“NO” in S31 and S32 of FIG. 8). As a result, the ready flags of the memory access instructions B LOAD2 and A LOAD1 become RDY_flg=1 and can be issued from the RSA (“YES” in S33, S34).

With the barrier control described above, the RSA does not issue the barrier microinstruction until the processing of the branch instruction before the barrier microinstruction is completed, and does not issue a memory access instruction after the barrier microinstruction until the barrier microinstruction is issued. As a result, the RSA does not issue a memory access instruction after the branch instruction until the processing of all branch instructions JMP1 C (BBM) before the barrier microinstruction is completed. As a result, the memory access instructions B LOAD2 and A LOAD1 after the BJMP1 C barrier microinstruction are not speculatively executed to overtake a branch instruction before the barrier microinstruction. After completion processing of the branch instruction JMP1 C (BBM), since the memory access instruction A LOAD1 of the correct branch destination is executed and the memory access instruction B_LOAD2 is not speculatively executed, a secret value is not read from the memory and not registered in the L1 data cache.

### Example_2: In Case where an Instruction Appended with a Barrier Attribute Flag is a Memory Access Instruction

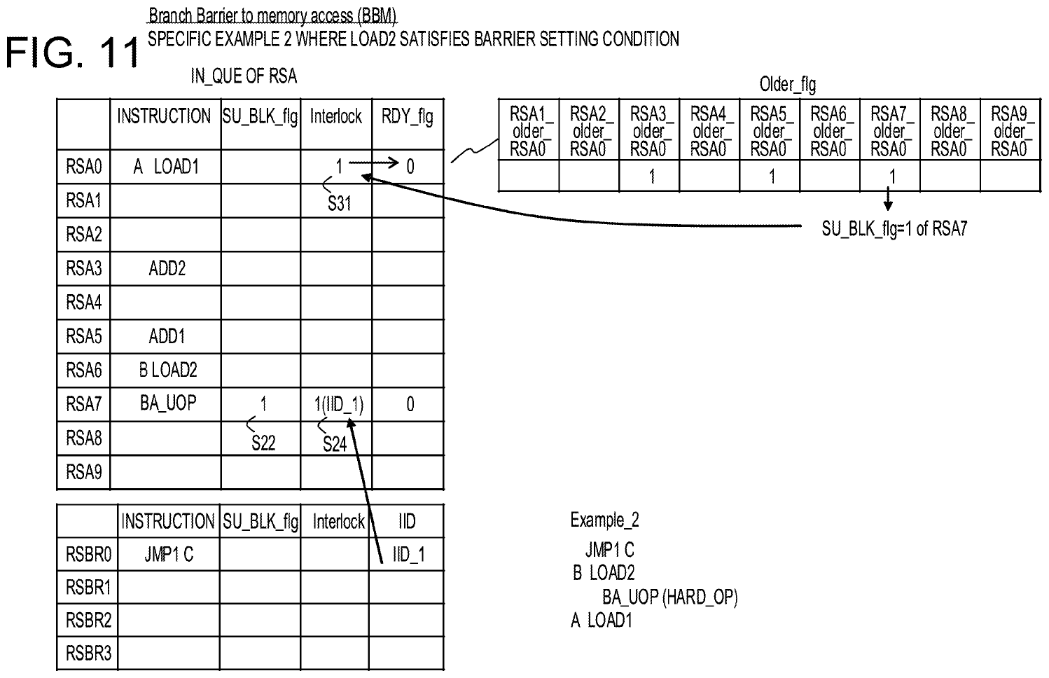

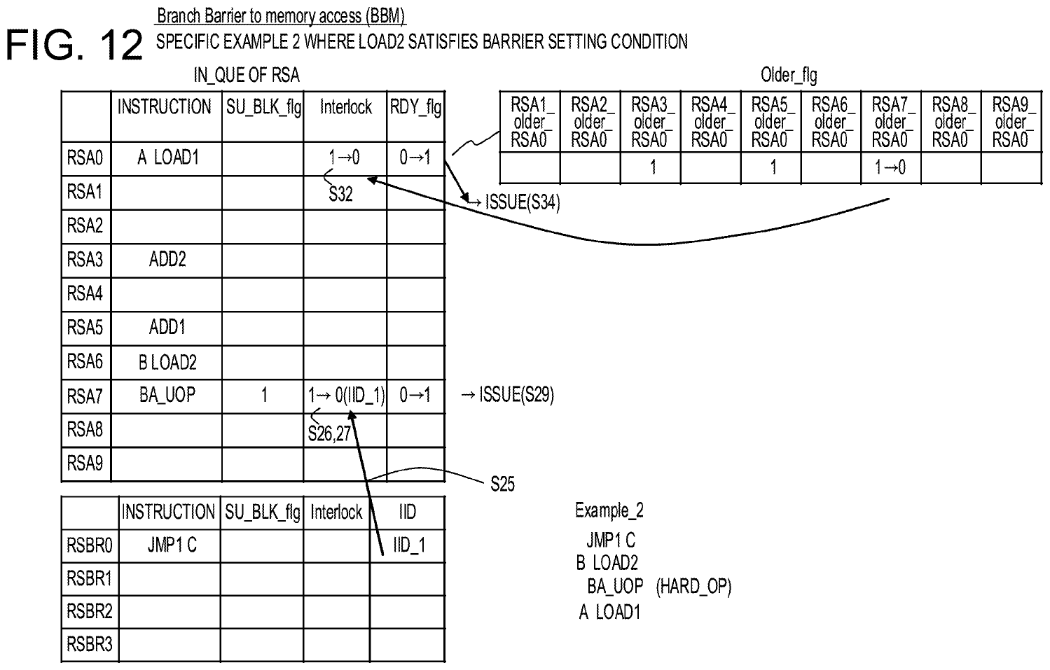

FIGS. 11 and 12 are views illustrating an example of a configuration of input queues of RSA and RSBR. FIG. 11 illustrates an instruction string having a branch instruction JMP C and two memory access (load) instructions B LOAD2 and A LOAD1 illustrated in FIG. 1 as Example_2. In Example_2, since the first memory access instruction B LOAD2 corresponds to the BBM attribute and is appended with the BBM attribute flag, a barrier microinstruction BA_UOP is added after the memory access instruction B LOAD2. In this case, the barrier setting circuit BA_SET outputs the branch instruction JMP1 C, the BBM attribute flag-appended memory access instruction B LOAD2 (BBM), the barrier microinstruction BA_UOP, and the subsequent memory access instruction B LOAD1 to the instruction decoder I_DEC. Then, the instruction decoder allocates the branch instruction JMP1 C to the RSBR and issues the barrier microinstruction BA_UOP and the two memory access instructions B LOAD2 (BBM) and B LOAD1 to the RSA.

The barrier controls BC1 and BC2 in the RSA are the same as those illustrated in FIGS. 7 and 8 described in Example_1. The processing for the branch instruction in the RSBR is also the same as that in Example_1.

The barrier microinstruction BA_UOP added after the barrier attribute flag-appended memory access instruction B LOAD2 (BBM) is queued in, and the RSA generates an entry thereof in the input queue (S21 in FIG. 7). The RSA generates an entry in the barrier microinstruction BA_UOP with the SU block flag as SU_BLK_flg=1. Then, since the branch instruction JMP1 C immediately before the barrier microinstruction has not yet been completed (“YES” in S23), the RSA sets the interlock of the barrier microinstruction to Interlock=1, stores the IID of the branch instruction JMP1 C (S24), and suppresses issuance of the memory access instruction B LOAD2 (BBM) until the branch instruction JMP1 C is completed. When the interlock is set to Interlock=1, the ready flag RDY_flg is set to “0” which is not the issuance ready state.

Meanwhile, in FIG. 8, the RSA determines whether or not an instruction having its own order older than (in front of) the memory access instruction A LOAD1 after the barrier microinstruction and having SU_BLK_flg=1 exists in the input queue IN_QUE (S30). When the determination result is true (“YES” in S30), the RSA sets the interlock of the memory access instruction A LOAD1 to Interlock=1 (S31). By the Interlock=1, the ready flag becomes RDY_flg=0, and the subsequent memory access instruction A LOAD1 may not be issued from the RSA.

Next, a transition is made to the input queue state of FIG. 12. In FIG. 7, when the branch instruction JMP1 C has been completed with successful branch prediction, the RSA receives from the RSBR a report that the IID of JMP1 C has been completed with the successful branch prediction (“YES” in S25). Then, the RSA detects that the IID of the completion report matches the IID stored in the barrier microinstruction (“YES” in S26) and releases the interlock of the barrier microinstruction to Interlock=0 (S27). Thereafter, the RSA detects that the barrier microinstruction is the oldest instruction with the ready flag RDY_flg=1 (“YES” in S28) and issues the barrier microinstruction to the memory access control circuit MEM_AC_CNT of the L1 data cache (S29).

Since the barrier microinstruction disappears from the input queue when the barrier microinstruction is issued from the RSA, the older flag Older_flg of the entry of each RSA is also updated, and the interlock of the subsequent memory access instruction A LOAD1 is released to Interlock=0 (“NO” in S30 and S32 of FIG. 8). As a result, the ready flag of the subsequent memory access instruction A LOAD1 becomes RDY_flg=1 and can be issued from the RSA (“YES” in S33 and S34).

With the barrier control described above, the RSA does not issue the barrier microinstruction until the processing of the branch instruction before the barrier microinstruction is completed, and does not issue the memory access instruction A LOAD1 after the barrier microinstruction until the barrier microinstruction is issued. As a result, the RSA does not issue the memory access instruction A LOAD1 after the barrier microinstruction until the processing of the branch instruction JMP1 C (BBM) before the barrier microinstruction is completed. As a result, the memory access instruction A LOAD1 after the barrier microinstruction is not speculatively executed to overtake the branch instruction JMP1 C before the memory access instruction of the barrier microinstruction.

In this case, since the memory access instruction A_LOAD1 is executed after the branch processing of the branch instruction JMP1 is completed, the memory access instruction B LOAD2 is speculatively executed, but due to a branch prediction miss, the secret value in the register X0 of the memory access instruction B LOAD2 is cleared. Thereafter, even when the memory access instruction A LOAD1 is executed, since the secret value in the register X0 is unclear, data cannot be registered in a cache line with the secret value as an address.

<Memory Barrier to Memory Access (MBM)>

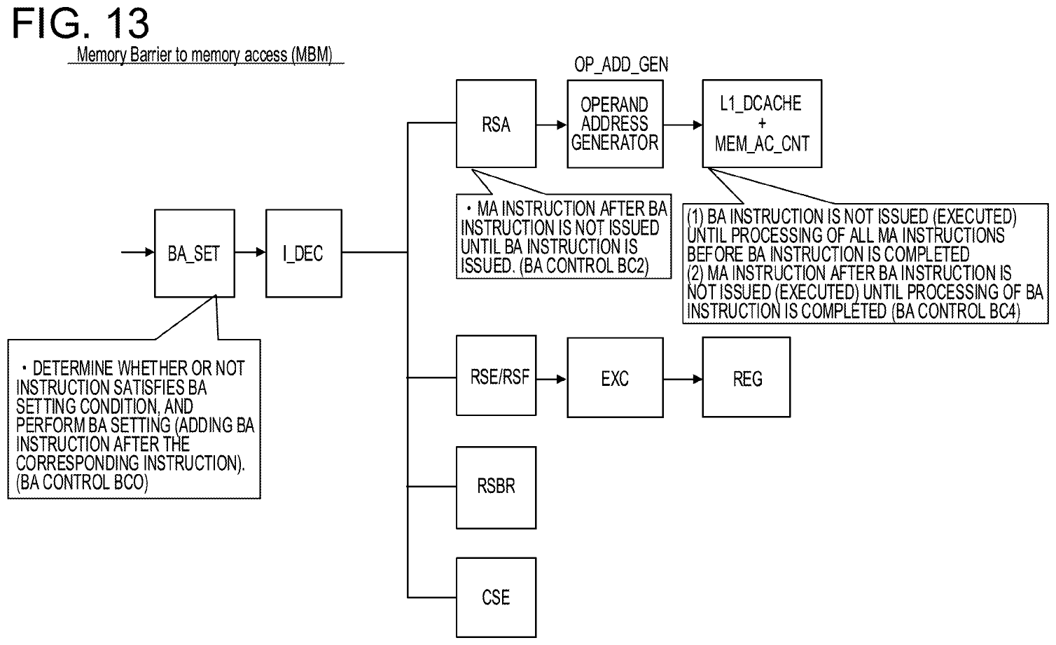

FIG. 13 is a view illustrating an outline of the order guarantee control (barrier control) in the processor related to a barrier microinstruction of the MBM attribute. First, like the barrier microinstruction of the BBM attribute in FIG. 6, the barrier setting circuit BA_SET determines whether or not the fetch instruction input from the instruction buffer corresponds to the barrier setting condition of MBM. When the fetch instruction corresponds to the barrier setting condition of MBM, the barrier setting circuit BA_SET performs barrier setting to add a barrier microinstruction after the fetch instruction corresponding to the barrier setting condition (barrier control BA0). Then, the RSA and the memory access control circuit MEM_AC_CNT perform the following barrier control on the barrier microinstruction.

In the case of the MBM attribute, the processor performs the order guarantee control to guarantee that a memory access instruction after the barrier microinstruction is not speculatively executed to overtake a memory access instruction before the barrier microinstruction.

For this order guarantee control, when a barrier microinstruction is included in an execution instruction input from the instruction decoder I_DEC, the RSA firstly does not issue a memory access instruction after the barrier microinstruction (the barrier attribute-appended memory access instruction or the barrier flow instruction) until the barrier microinstruction (the barrier attribute-appended memory access instruction or the barrier flow instruction) is issued (BC2). However, the barrier microinstruction may be issued to overtake a memory access instruction before the barrier microinstruction.

By performing the issuance control to guarantee that the RSA does not issue a memory access instruction after the barrier microinstruction until the barrier microinstruction is issued (BC2), the barrier microinstruction and the subsequent memory access instruction are queued in an in-order in the fetch port queue FP_QUE of the memory access control circuit MA_AC_CNT.

Secondly, the memory access control circuit manages the memory access instruction notified from the RSA in a fetch port queue where the processing of the memory access instruction can be completed in the order of programs. That is, (1) the fetch port queue FP_QUE of the memory access control circuit MEM_AC_CNT does not issue the barrier microinstruction until the processing of all of the memory access instructions before the barrier microinstruction is completed. In addition, (2) the fetch port queue does not issue (and execute) a memory access instruction after the barrier microinstruction until the processing of the barrier microinstruction is completed. The items (1) and (2) are the barrier control BC4.

As a result, the fetch port queue does not issue (and execute) the barrier microinstruction and the subsequent memory access instruction until the processing of the memory access instruction before the barrier microinstruction is completed.

The processor implements the above-described order guarantee control by a combination of the items (1) and (2) of the barrier control BC4 of the fetch port queue and the “barrier control BC2 which does not issue the memory access instruction after the barrier microinstruction until the barrier microinstruction is issued” by the RSA. That is, the order guarantee control is a control to guarantee that “a memory access instruction after a barrier microinstruction is not speculatively executed to overtake the memory access instruction before the barrier microinstruction.”

In the case of the barrier microinstruction having the BBM barrier attribute described above, since the RSA issues the barrier microinstruction after completion of processing of the branch instruction before the barrier microinstruction, there is no need to perform the barrier control BC4 in the fetch port queue in the memory access control circuit.

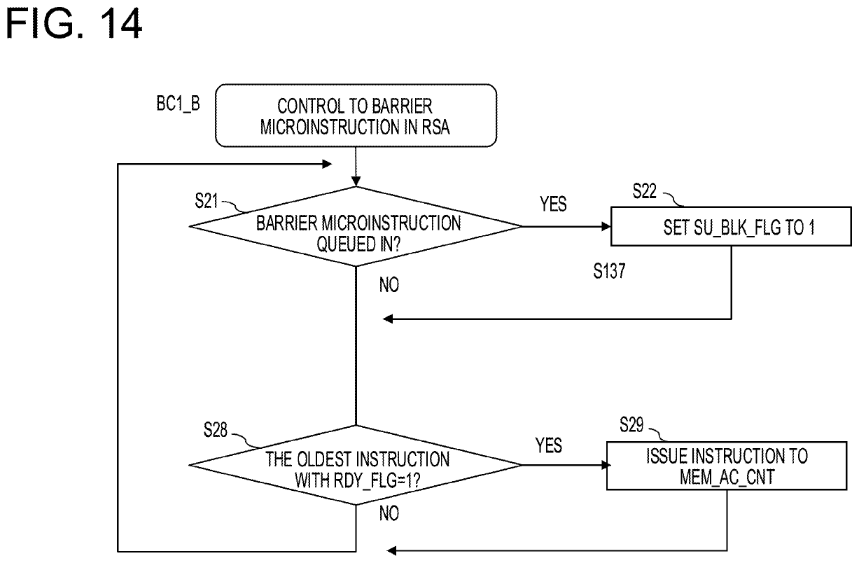

FIG. 14 is a flowchart of barrier control BC1_B for the barrier microinstruction in the RSA. In the barrier control BC1_B, steps S23 to S27 are deleted from the barrier control BC1 in FIG. 7. That is, when the barrier microinstruction is queued (“YES” in S21), the RSA sets the storage unit block flag SU_BLK_flg of the barrier microinstruction to “1” (S22). Then, the RSA issues the oldest instruction whose ready flag RDY_flg is “1,” among the queued instructions, to the memory access control circuit MEM_AC_CNT.

Hereinafter, the barrier control in the RSA will be described by way of Example_3. In this barrier control, in addition to the flowchart of the barrier control for the barrier microinstruction in FIG. 14, reference is also made to the flowchart of the barrier control BC2 for the instructions other than the barrier microinstruction in the RSA illustrated in FIG. 8.

### Example_3

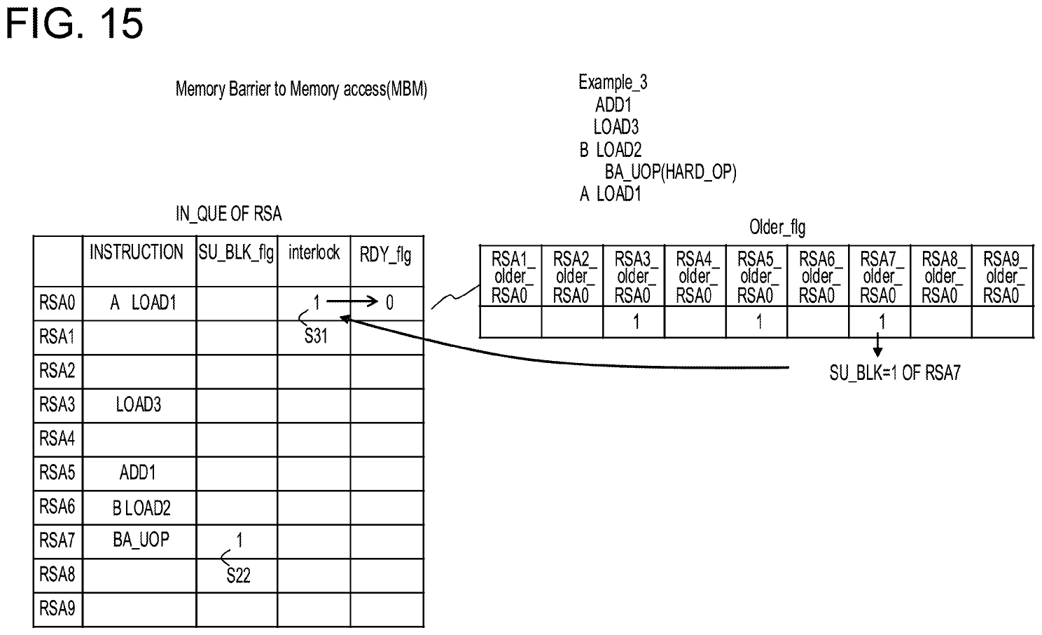

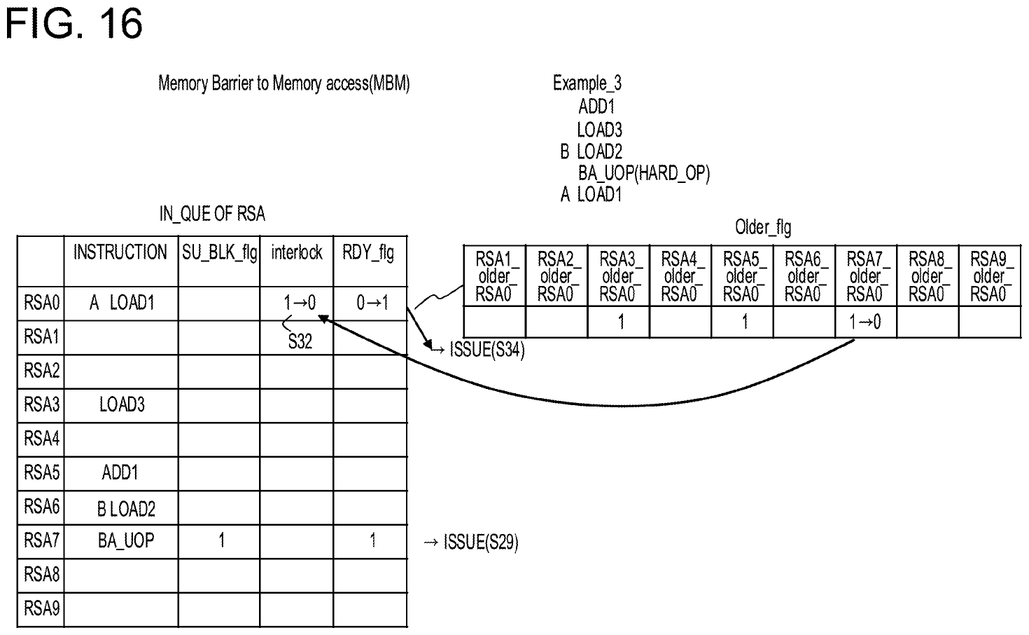

FIGS. 15 and 16 are views illustrating an example of barrier control in the RSA for Example_3 in which a barrier microinstruction is added after an instruction appended with the MBM attribute flag. Example_3 illustrated in FIG. 15 is an instruction string including an addition instruction ADD1, three memory access instructions LOAD3, B LOAD2, and A LOAD1, and a barrier microinstruction BA_UOP added after the memory access instruction B LOAD2. The instruction string is queued in an in-order from the instruction decoder into the RSA. The RSA issues the instruction string to the memory access control circuit in an out-of-order between the memory access instructions LOAD3 and B LOAD2 and the barrier microinstruction BA_UOP, and in an in-order between the barrier microinstruction BA_UOP and the memory access instruction A LOAD1.

When the barrier microinstruction is queued in the input queue IN_QUE of the RSA in FIG. 15 (“YES” in S21), the RSA generates an entry in the barrier microinstruction BA_UOP with the storage unit block flag SU_BLK_flg=1.

Meanwhile, the RSA determines whether or not an instruction having its own order older than (in front of) the memory access instruction A LOAD1 after the barrier microinstruction and having SU_BLK_flg=1 exists in the input queue IN_QUE (S30 in FIG. 8). In the example of FIG. 15, since the barrier microinstruction BA_UOP having an order older than the memory access instruction A LOAD1 and having SU_BLK_flg=1 exists in the input queue IN_QUE, the determination result is true (“YES” in S30). Accordingly, the RSA sets the interlock of the memory access instruction A LOAD1 to Interlock=1 (S31). By the Interlock=1, the ready flag becomes RDY_flg=0, and the memory access instruction A LOAD1 may not be issued from the RSA.

Next, a transition is made to the input queue state of FIG. 16. As illustrated in FIG. 14, since no interlock is applied to the barrier microinstruction, the ready flag RDY_flg becomes “1” when the barrier microinstruction can solve the problem of the read-after-write, and the barrier microinstruction is issued from the RSA when the barrier microinstruction becomes the oldest instruction (“YES” in S28 and S29 of FIG. 14). By the issuance, the barrier microinstruction is erased from the RSA and is reflected in the older flag of each entry. As a result, the interlock of the memory access instruction A LOAD1 is released to “0” (S32 in FIG. 8), and the ready flag becomes the issue ready state “1.” Thereafter, the RSA issues the memory access instruction A LOAD1 (S34 in FIG. 8).

With the above barrier controls BC1_B and BC2, the barrier microinstruction and the subsequent memory access instruction A LOAD1 are queued in an in-order from the RSA into the fetch port queue FP_QUE in the SU access control circuit.

With the above barrier controls, the RSA does not issue a memory access instruction after the barrier microinstruction until the barrier microinstruction is issued. As a result, the barrier microinstruction BA_UOP and the memory access instruction A LOAD1 are issued in-order from the RSA into the fetch port queue FP_QUE.

Secondly, the memory access control circuit MEM_AC_CNT performs completion processing in an in-order for all the memory access instructions before the barrier microinstruction, the barrier microinstruction, and the subsequent memory access instruction.

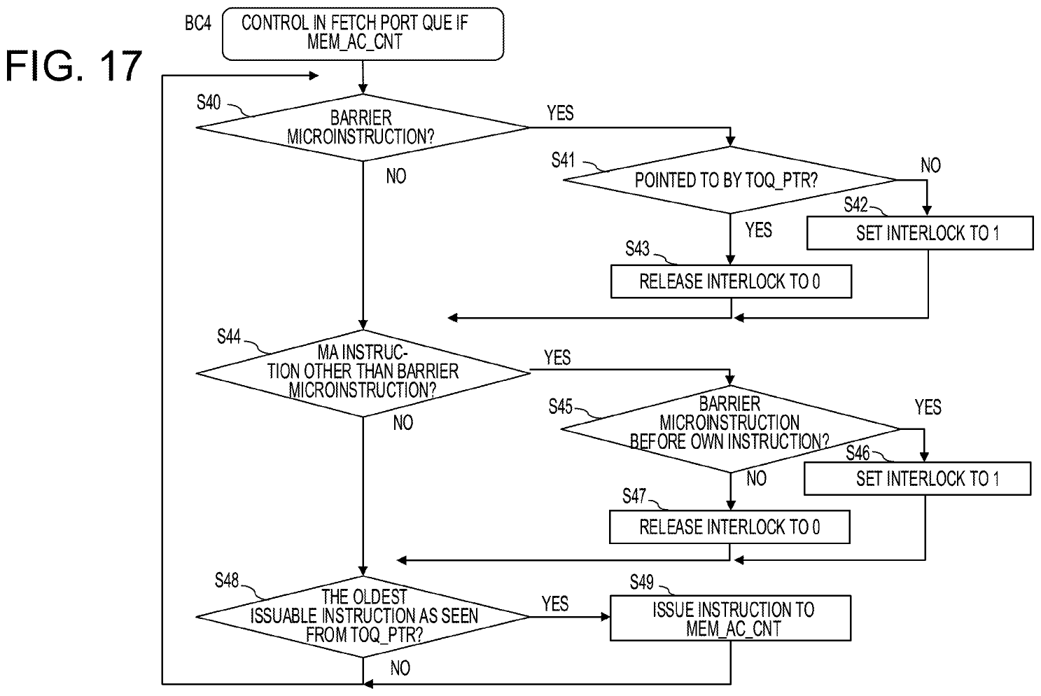

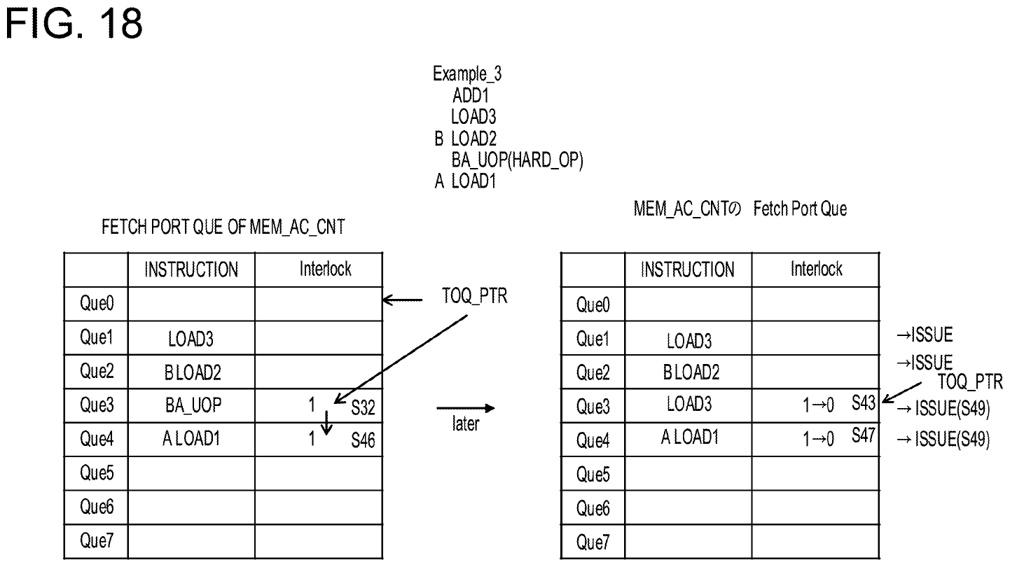

FIG. 17 is a flowchart illustrating an example of a control in the queue FP_QUE of the fetch port of the memory access control circuit. FIG. 18 is a view illustrating an example of the queue FP_QUE of the fetch port. FIG. 18 illustrates a state (the left side) in which the instruction of Example_3 is queued from the RSA and then a state (the right side) in which the instruction is issued from the fetch port.

The input queue of the memory access control circuit MEM_AC_CNT is called a fetch port, and queue numbers Que0 to Que7 are cyclically allocated to instructions in the order of programs in an in-order. The cyclic allocation means that the queue number Que0 is allocated next to the queue number Que7. Therefore, a top-of-queue pointer TOQ_PTR indicating which entry of the queue is the oldest entry is managed.

The rule of issuance from the fetch port queue to the memory access control circuit is to issue an instruction of the oldest entry that can be issued. Therefore, an instruction of the issuable entry first found after looking backward from the entry of TOQ_PTR is issued. The issuable state refers to, for example, a state in which a memory address of a memory access instruction issued from the RSA is known and is not interlocked. The memory address is generated, for example, by an arithmetic operation by the operand address generation circuit.

Therefore, since an instruction is issued in an out-of-order from the RSA, it cannot be said that the memory access instruction is necessarily completed in the order of queue numbers in the fetch port queue. Therefore, the barrier control BC4 for order guarantee to be described below is performed.

A memory access instruction requesting memory access is queued in the fetch port of the memory access control circuit. The memory access instruction has a short latency when a cache hit occurs in the L1 data cache, but has a long latency when a cache miss occurs and an access to the main memory occurs. In addition, the memory access instruction may be aborted during an access control by the memory access control circuit and issued again from the fetch port. The memory access instruction issued from the fetch port disappears from the fetch port when the memory access processing is completed, a data response is received, and the top-of-queue pointer TOQ_PTR points to the memory access instruction. As a result, the fetch port allocates the entry of the memory access instruction in-order, and also opens the entry in an in-order. However, the memory access instruction is issued in an out-of-order.

On the left side of FIG. 18, entries of LOAD3, B LOAD2, BA_UOP, and A LOAD1 in the instruction string of Example_3 are generated in Que2 to 4 of the fetch port queue. As described above, the RSA controls the issuance of the barrier microinstruction BA_UOP and the subsequent memory access instruction A LOAD1 in-order, but may issue in an out-of-order between the memory access instructions LOAD3 and B LOAD2 before the barrier microinstruction BA_UOP. However, the fetch port interlocks the barrier microinstruction BA_UOP and the subsequent memory access instruction A LOAD1 according to the following control, so as to suppress the issuance until the memory access instructions LOAD3 and B LOAD2 before the barrier microinstruction BA_UOP are queued in the fetch port.

That is, as illustrated in FIG. 17, when the memory access instruction B LOAD2 is a barrier microinstruction (“YES” in S40) and is not pointed to by the top-of-queue pointer TOQ_PTR (“NO” in S41), the fetch port queue sets the interlock of the barrier microinstruction to “1” and inhibits the issuance until all the memory access instructions before the barrier microinstruction BA_UOP are issued (S42).

At the same time, when the memory access instruction is an instruction after the barrier microinstruction (“YES” in S44) and the barrier microinstruction before the memory access instruction is entered in the fetch port queue (“YES” in S45), the fetch port queue sets the interlock to “1” and inhibits the issuance until the barrier microinstruction is issued.

Meanwhile, when the barrier microinstruction BA_UOP is pointed to by TOQ_PTR (“YES” in S41), the fetch port queues releases the interlock of the barrier microinstruction to “0” (S43) and releases the interlock of the memory access instruction A LOAD1 after the barrier microinstruction to “0” (S45 and S47).

Then, the fetch port issues the oldest (earliest) issuable instruction as seen from TOQ_PTR (“YES” in S48) to the memory access control circuit (S49).

According to the control of the fetch port, the barrier microinstruction BA_UOP and the subsequent memory access instruction A LOAD1 stay in the fetch port until the memory access instruction LOAD3 before the barrier microinstruction is queued, issued, and completed in the fetch port and disappears from the fetch part. The state on the left side of FIG. 18 represents a state when the memory access instruction LOAD3 is queued.

Next, on the right side after the passage of time from the left side of FIG. 18, when the memory access instructions LOAD3 and B LOAD2 before the barrier microinstruction of Que3 are issued and completed, the top-of-queue pointer TOQ_PTR points to the barrier microinstruction BA_UOP (“YES” in S41). Then, the fetch port queue releases the interlock of the barrier microinstruction BA_UOP to “0” (S43). As a result, the barrier microinstruction is issued to the memory access control circuit (“YES” in S48 and S49).

When the barrier microinstruction is issued and thereafter completed and disappears from the fetch port queue, the interlock of the memory access instruction A LOAD1 of Que4 is released to “0” (“NO” in S45 and S47). Thereafter, the memory access instruction A LOAD1 is issued from the fetch port queue (S49) and thereafter is completed. A plurality of memory access instructions after the barrier microinstruction is issued and executed in an out-of-order after the barrier microinstruction is completed.

As described above, according to the barrier control in the RSA and the barrier control in the fetch port of the memory access control circuit, the order guarantee for the barrier microinstruction of the MBM attribute is complied. As a result, the processor prevents the memory access instruction A LOAD1 after the barrier microinstruction from being speculatively executed until the memory access instructions LOAD3 and B LOAD2 before the barrier microinstruction are completed.

In the above example, the memory access instruction A_LOAD1 after the memory access instruction B LOAD2 is not speculatively executed until the processing of the memory access instruction B LOAD2 is completed. Therefore, the memory access instruction B LOAD2 is trapped for a load into the privileged area and the secret value in the register X0 is cleared. Thereafter, even when the memory access instruction A LOAD1 is executed, data cannot be registered in a cache line in the L1 data cache with the secret value as an address, and the secret value is unknown.

<All Barrier to Memory Access (ABM)>

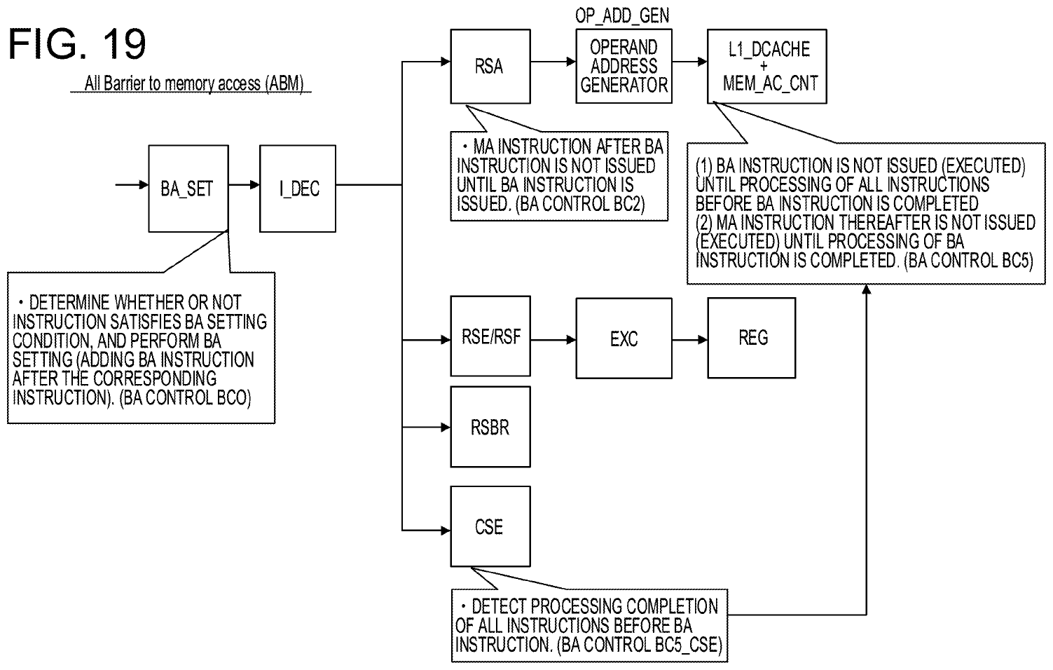

FIG. 19 is a view illustrating an outline of the order guarantee control (barrier control) in the processor related to the barrier microinstruction of the ABM attribute. The control BC0 of the barrier setting circuit BA_SET is the same as the case of the MBM attribute.

In the case of the ABM attribute, the processor performs the order guarantee control to guarantee that the memory access instruction after the barrier microinstruction of the barrier attribute ABM is not speculatively executed to overtake all the instructions (being not limited to the memory access instruction as in MBM) before the barrier microinstruction.

For the order guarantee control, when a barrier microinstruction is included in an execution instruction input from the instruction decoder I_DEC, the RSA firstly does not issue a memory access instruction after the barrier microinstruction until the barrier microinstruction is issued (BC2). Therefore, the memory access instruction after the barrier microinstruction is issued to the memory access control circuit after the barrier microinstruction.

By performing the issuance control to guarantee that the RSA does not issue a memory access instruction after the barrier microinstruction until the barrier microinstruction is issued (BC2), the barrier microinstruction and the memory access instruction after the barrier microinstruction are queued in an in-order in the fetch port queue FP_QUE of the memory access control circuit MA_AC_CNT. The control BC2 is also the same as the control of the RSA of the MBM attribute.

Secondly, the memory access control circuit manages the memory access instruction notified from the RSA in a fetch port queue where the processing of the memory access instruction can be completed in the order of programs. (1) The fetch port queue FP_QUE of the memory access control circuit MEM_AC_CNT does not issue the barrier microinstruction until the processing of all of the instructions before the barrier microinstruction is completed. In addition, (2) the fetch port queue does not issue a memory access instruction after the barrier microinstruction until the processing of the barrier microinstruction is completed (barrier control BC5).

Thirdly, the completion of processing of all of the instructions before the barrier microinstruction may be detected based on a determination as to whether or not the IID of the top-of-queue pointer of the input queue of CSE matches the IID of the barrier microinstruction. In the detection processing, the fetch port detects that all the instructions before the barrier microinstruction have been processed, and performs a control ((1) of BC5) to issue the barrier microinstruction.

As a result, the fetch port queue does not issue the barrier microinstruction and the subsequent memory access instruction until the processing of all the instructions before the barrier microinstruction is completed.

Hereinafter, the barrier control in the RSA will be described by way of Example_4. In the barrier control, in addition to the flowchart of the barrier control for the barrier microinstruction in FIG. 14, reference is also made to the flowchart of the barrier control BC2 for the instructions other than the barrier microinstruction in the RSA illustrated in FIG. 8.

### Example_4

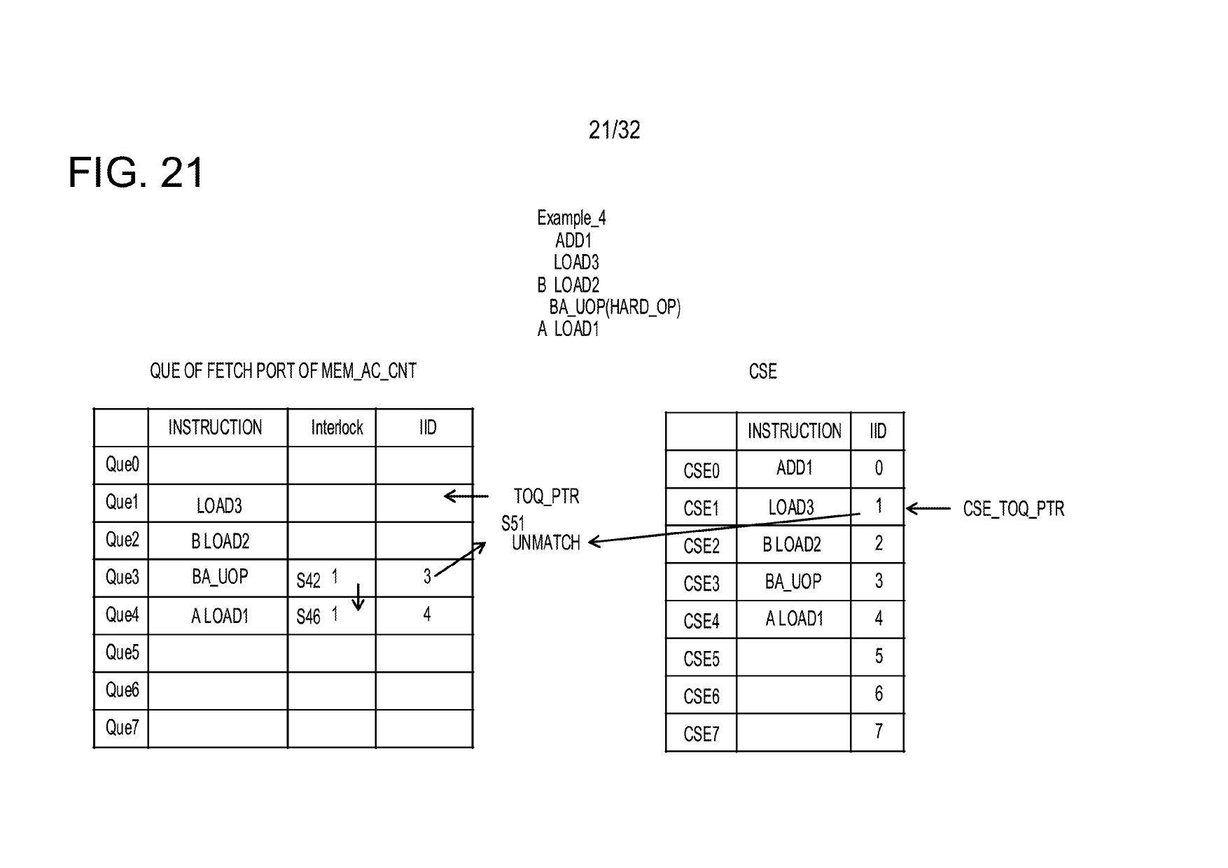

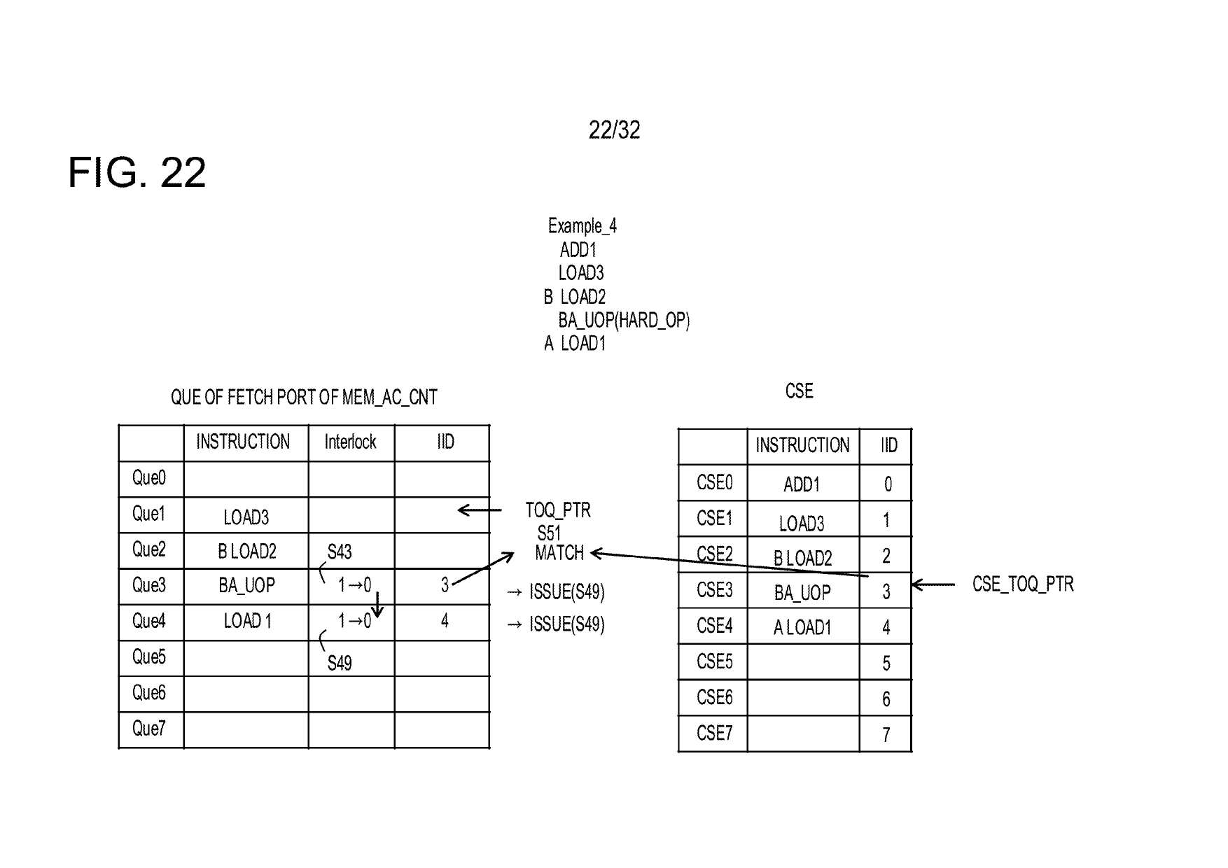

As illustrated in FIGS. 21 and 22, the instruction string of Example_4 is the same as the instruction string of Example_3 illustrated in FIGS. 15 and 16.

Firstly, the barrier controls BC1_B and BC2 by the RSA are the same as the barrier controls BC1_B and BC2 illustrated in FIGS. 15 and 16 for the barrier attribute MBM. Secondly, the barrier control BC5 in the fetch port of the memory access control circuit is as follows.

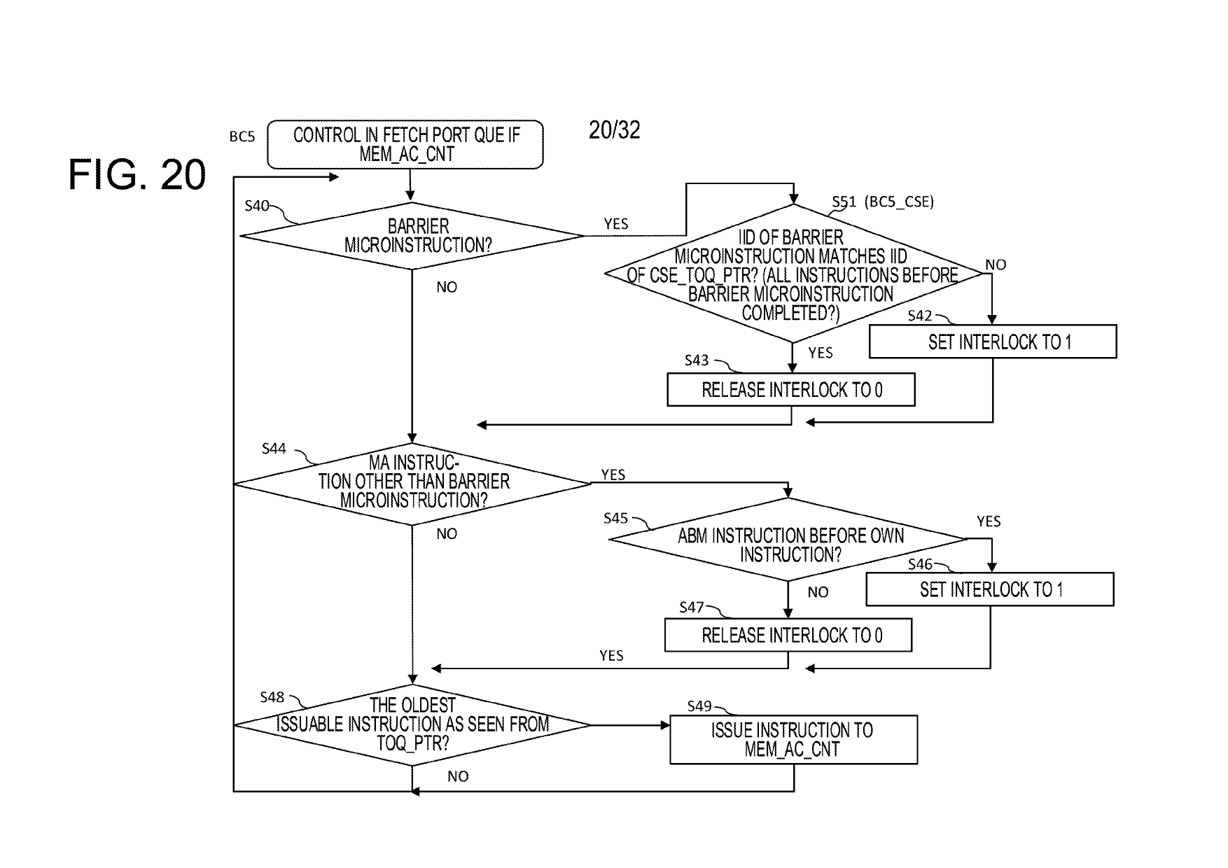

FIG. 20 is a flowchart of the barrier control BC5 in the fetch port of the memory access control circuit. The steps S40 and S42 to S49 of the flowchart of FIG. 20 are the same as the steps S40 and S42 to S49 of FIG. 17. However, the step S51 of the flowchart of FIG. 20 is different from the step S41 of FIG. 17. Specifically, the fetch port determines whether or not an instruction ID (IID) pointed to by the top-of-queue pointer CSE_TOQ_PTR of the CSE matches the IID of the barrier microinstruction, and determines whether or not the processing of all the instructions before the barrier microinstruction has been completed (S51).

According to the flowchart of FIG. 20, when an instruction having an entry generated in the queue is a barrier microinstruction (S40), and when the instruction ID (IID) pointed to by the top-of-queue pointer CSE_TOQ_PTR of the CSE does not match the IID of the barrier microinstruction (“NO” in S51), the fetch port sets the interlock of the barrier microinstruction to “1” to prohibit the issuance. Meanwhile, when the pointed-to instruction ID (IID) matches the IID of the barrier microinstruction (“YES” in S51), the fetch port releases the interlock of the barrier microinstruction to “0” to permit the issuance (S43). Thereafter, when the barrier microinstruction becomes the oldest issuable instruction, it is issued and executed by the memory access control circuit.

Meanwhile, when the instruction in the queue of the fetch port is a memory access instruction other than the barrier microinstruction (S44), and when there is a barrier microinstruction before the memory access instruction (“YES” in S45), the interlock is set to “1” (S46). When the barrier microinstruction disappears (“NO” in S45), the interlock is released to “0” (S47).

FIGS. 21 and 22 are views for explaining the barrier control BC5 in the fetch port of the memory access control circuit for Example_4. FIGS. 21 and 22 illustrate a queue of the fetch port of the memory access control circuit and a queue of the CSE.

In the CSE queue, all instructions of an instruction string are entered, IID is allocated to all the instructions, and the top-of-queue pointer CSE_TOQ_PTR is shifted every time the processing of all the instructions is completed. Meanwhile, in the fetch port of the memory access control circuit, memory access instructions in an instruction string are entered, and respective interlocks Interlock and IIDs are held. Therefore, by checking an IID pointed to by the top-of-queue pointer CSE_TOQ_PTR of the CSE, it is possible to know to which instruction the completion processing has been performed.

In the state of FIG. 21, the top-of-queue pointer CSE_TOQ_PTR of the CSE points to LOAD3, and IID=1 of LOAD3 does not match IID=3 of the barrier microinstruction BA_UOP in the fetch port of the memory access control circuit (“NO” in S51). Therefore, the fetch port sets the interlock of the barrier microinstruction to “1” to prohibit the issuance (S42). Along with the operation, since the barrier microinstruction BA_UOP exists before the instruction A LOAD1 (“YES” in S45), the interlock of the instruction A LOAD1 is also set to “1” to prohibit the issuance (S47).

Next, in the state of FIG. 22, the top-of-queue pointer CSE_TOQ_PTR of the CSE points to the barrier microinstruction BA_UOP, and its IID=3 matches the IID=3 of the barrier microinstruction BA_UOP in the fetch port (“YES” in S51). Therefore, the fetch port releases the interlock of the barrier microinstruction to “0” to permit the issuance (S43). Thereafter, the barrier microinstruction is issued (S49). Along with this, since the barrier microinstruction BA_UOP does not exist before the instruction A LOAD1 (“NO” in S45), the interlock of the instruction A_LOAD1 is also released to “0” (S47) to permit the issuance and thereafter the instruction A_LOAD1 is issued (S49).

As described above, according to the barrier control in the RSA and the barrier control in the fetch port of the memory access control circuit, the order guarantee for the barrier microinstruction of the ABM attribute is complied. As a result, it is possible to prevent the memory access instruction A LOAD1 after the barrier microinstruction BA_UOP from being speculatively executed until the processing of all instructions before the barrier microinstruction BA_UOP is completed.

In Example_4, since the memory access instruction A_LOAD1 is not executed until the processing of the memory access instruction B LOAD2 is completed, the memory access instruction B LOAD2 is trapped for an address to the privileged area and the secret value in the register X0 is cleared. Thereafter, even when the memory access instruction A LOAD1 is executed, data cannot be registered in a cache line in the L1 data cache with the secret value as an address, and the secret value is unknown.

<All Barrier to All (ABA)>

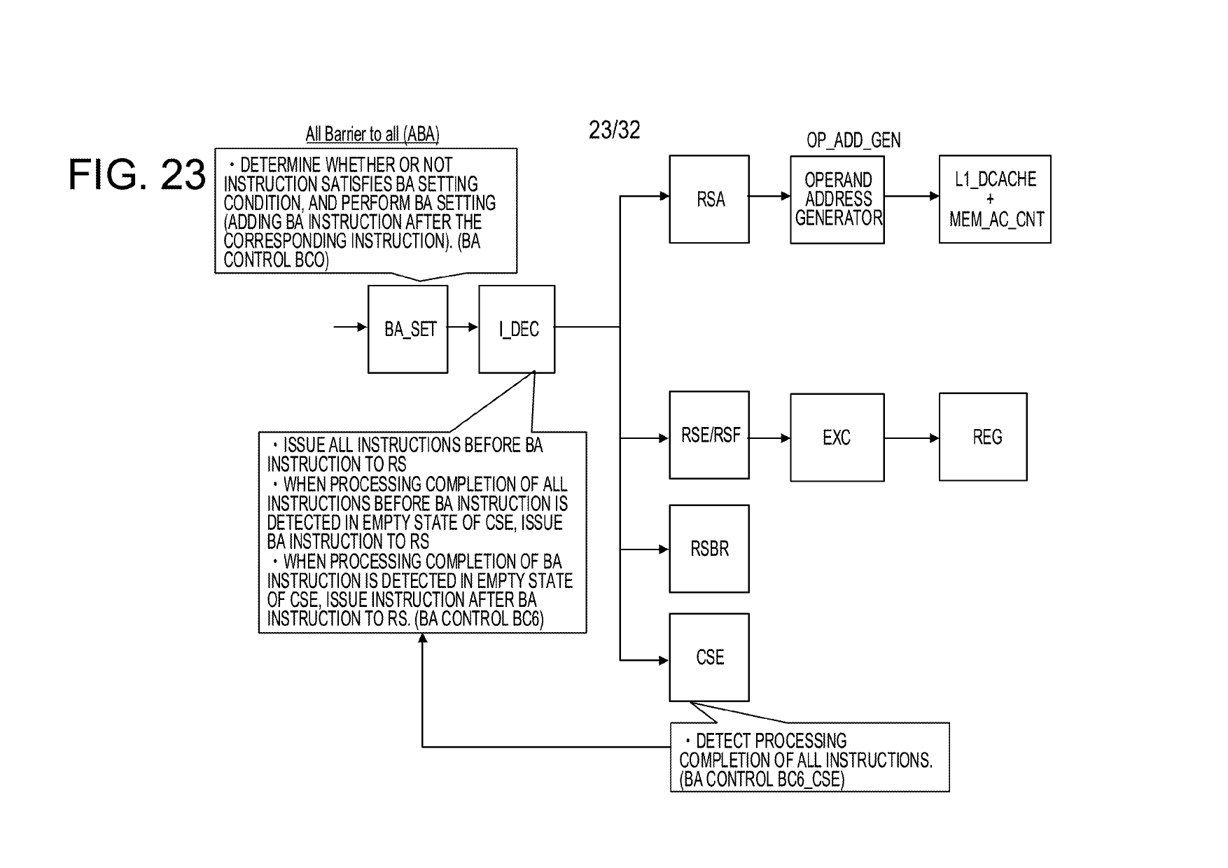

FIG. 23 is a view illustrating an outline of order guarantee control (barrier control) in the processor related to the barrier microinstruction of the barrier attribute ABM. In the case of the barrier attribute ABA, it is not permitted to overtake all instructions without being limited to memory access instructions. Therefore, a barrier control BC6 is performed by the instruction decoder to issue all the instructions.

Further, the instruction decoder determines that the processing of all the instructions before the barrier microinstruction has been completed and that the processing of the barrier microinstruction has been completed, based on an IID pointed to by the top-of-queue pointer of the CSE that completes the processing of all instructions (BC6_CSE).

As a result, the processor performs the order guarantee control to guarantee that all instructions after the barrier microinstruction of the barrier attribute ABA are not speculatively executed to overtake all the instructions before this barrier microinstruction.

First, the barrier setting circuit generates a barrier microinstruction (BC0). Next, for the order guarantee control, when receiving the barrier microinstruction from the barrier setting circuit BA_SET, the instruction decoder I_DEC (1) issues all instructions before the barrier microinstruction in an in-order to the corresponding RS and CSE, (2) issues the barrier microinstruction when the completion of processing of all instructions before the barrier microinstruction is detected by the fact that the CSE entered an empty state, and (3) issues instructions after the barrier microinstruction in-order when the completion of processing of the barrier microinstruction is detected by the fact that the CSE entered an empty state (BC5). The instruction decoder I_DEC detects the empty state of the CSE (BC6_CSE) based on a report of the completion of instruction processing from the CSE.

In this way, in the case of the barrier microinstruction of the barrier attribute ABA, all the instructions before the barrier microinstruction are executed and the completion of processing thereof is checked. Then, the barrier microinstruction is executed and the completion of processing thereof is checked. After that, all the instructions after the barrier microinstruction are executed. Therefore, the barrier control with the strictest regulation for order guarantee of instruction execution is performed. In this case, speculative execution for all instructions after the barrier microinstruction is not permitted. When the speculative execution of an instruction causes the processor vulnerability, the speculative execution may be prevented by adding the barrier microinstruction of the barrier attribute ABA to the instruction.

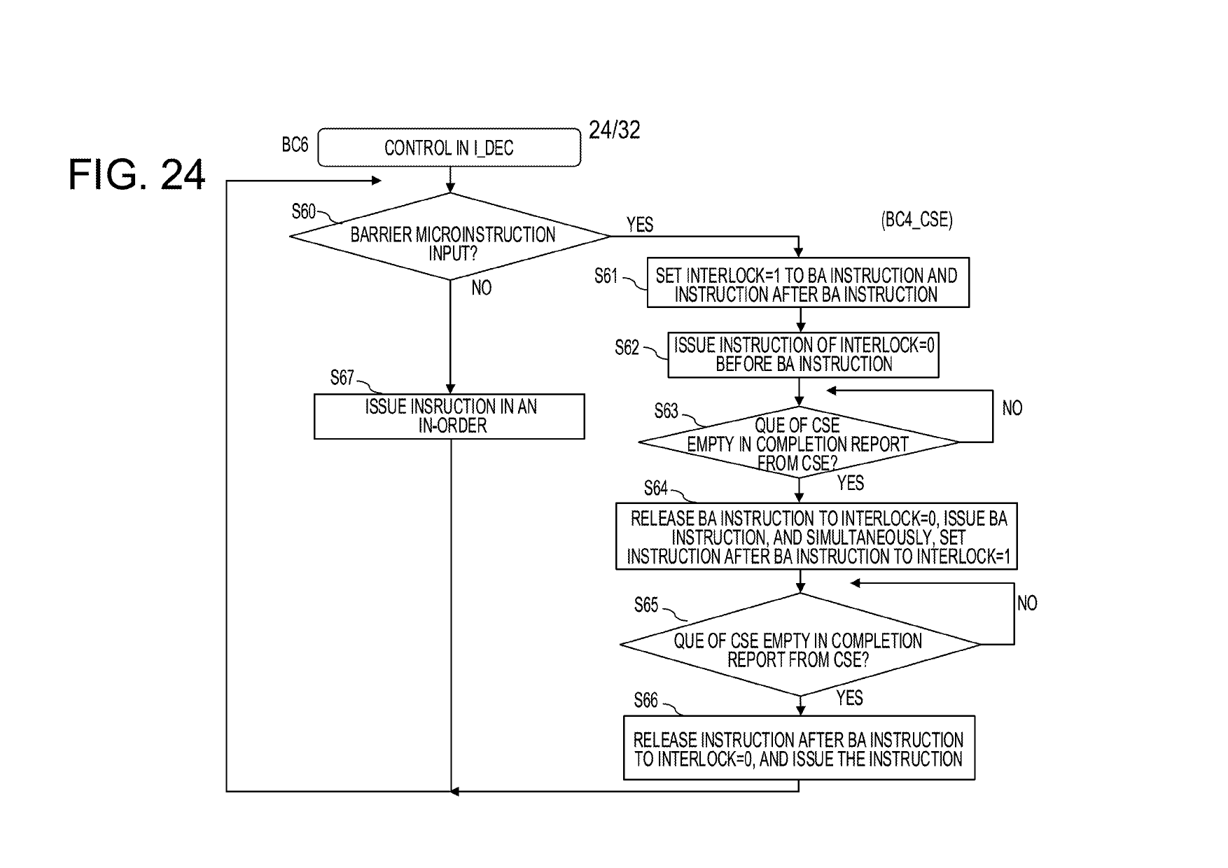

FIG. 24 is a flowchart illustrating the barrier control BC6 for the barrier microinstruction (BA instruction) and instructions before and after the barrier microinstruction in the instruction decoder. When a barrier microinstruction is input (“YES” in S60), the instruction decoder sets the interlocks of the barrier microinstruction and an instruction after the barrier microinstruction to “1” to prohibit the issuance (S61). Then, the instruction decoder issues an instruction having an interlock of “0” before the barrier microinstruction (S62).

Subsequently, the instruction decoder manages the number of instructions remaining in the queue of the current CSE by an instruction processing completion notification from the CSE, and detects that the CSE is empty when the number of instructions in the CSE is zero (“YES” in S63). In response to the detection of the empty state of the CES, the instruction decoder releases the interlock of the barrier microinstruction to “0” and issues the barrier microinstruction (S64). At the same time, the instruction decoder keeps the interlock of an instruction after the barrier microinstruction at “1” (S64).

Subsequently, the instruction decoder manages the number of instructions in the CSE by an instruction processing completion notification from the CSE, and detects that the CSE is empty when the number of instructions in the CSE is zero (“YES” in S65). In response to the detection of the empty state of the CES, the instruction decoder releases the interlock of the instruction after the barrier microinstruction to “0” and issues the instruction after the barrier microinstruction (S66).

While the barrier microinstruction is not input, the instruction decoder issues the instruction in an in-order to the RS and the CSE (S67).

### Example_5

In the case of the barrier attribute ABA, when the barrier setting condition is satisfied, the barrier setting circuit adds the barrier microinstruction after the barrier attribute-appended fetch instruction and outputs the fetch instruction and the barrier microinstruction in an in-order to the instruction decoder I_DEC.

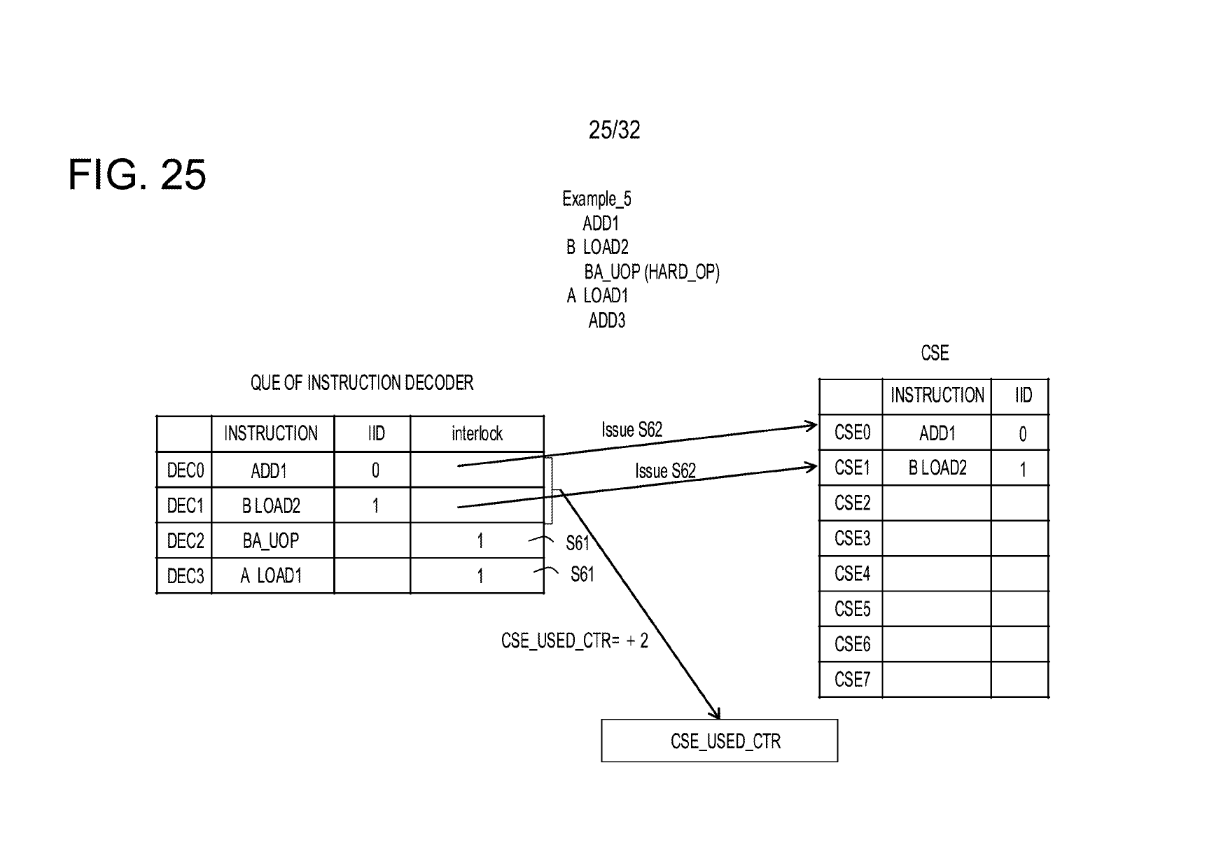

FIGS. 25, 26, and 27 are views for explaining the barrier control BC6 for an instruction string of Example_5. The barrier attribute ABA is appended to B LOAD2 of the instruction string.

In FIG. 25, it is assumed that ADD1, B LOAD2, BA_UOP, and A LOAD1 of the instruction string of Example_5 have already been input in the queue of the instruction decoder. In this case, the interlocks of the barrier microinstruction BA_UOP and the subsequent instruction B LOAD2 are set to “1” (S61). Then, the instruction decoder issues the instructions ADD1 and B LOAD2 in an in-order to the CSE and an RS (not illustrated) (S62). In addition, the instruction decoder manages the number of instructions in the CSE with a CSE use counter CSE_USE_CTR. Since the instruction decoder issued the two instructions ADD1 and B LOAD2 to the CSE, the count value of this CSE use counter is “2.”

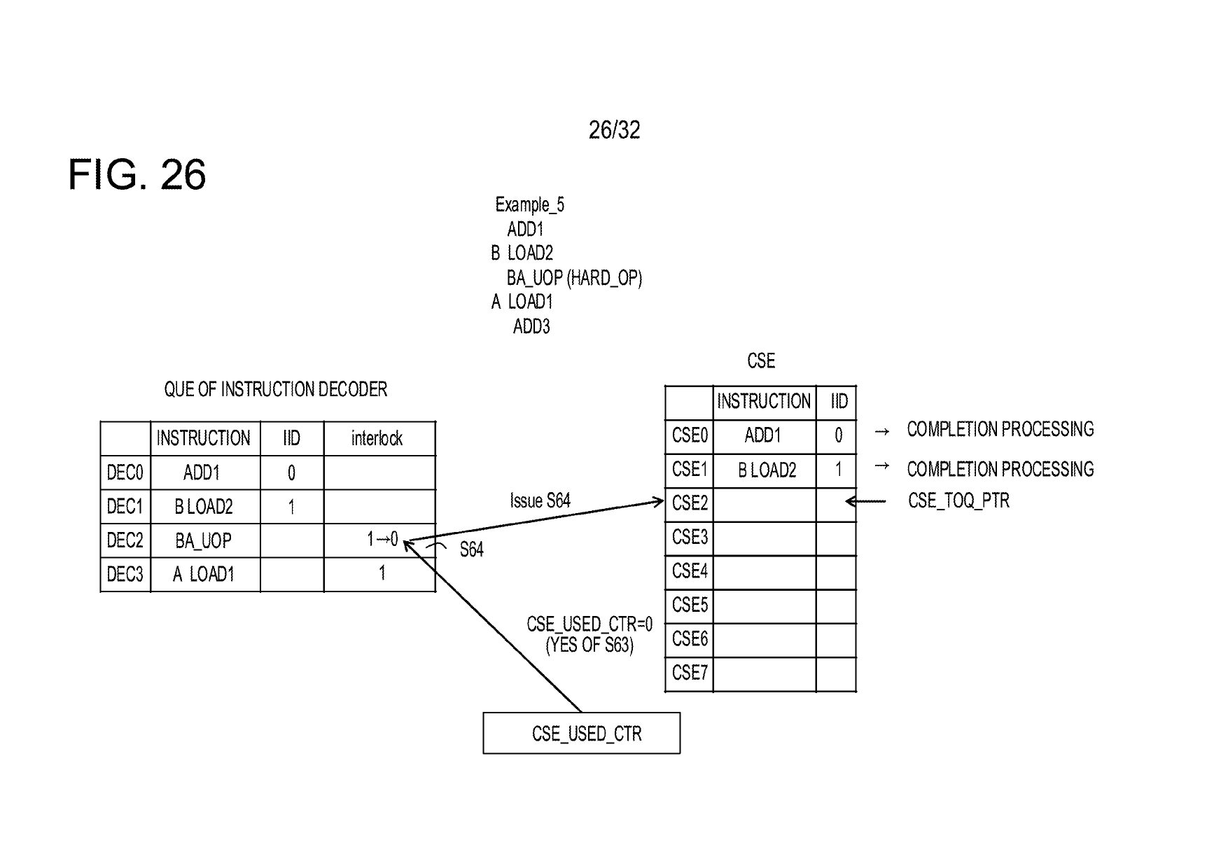

As illustrated in FIG. 26, the CSE performs completion processing of the two instructions ADD1 and B LOAD2, and the top-of-queue pointer CES_TOQ_PTR moves to CSE2. The count value of the CSE use counter managed by the instruction decoder becomes “0” based on a completion processing report of each of the two instructions from the CSE. Thereby, the instruction decoder detects that the CSE is in the empty state (“YES” in S63). As a result, the instruction decoder releases the interlock of the barrier microinstruction BA_UOP to “0” (S64) and then issues the barrier microinstruction BA_UOP to the CSE and the RS (not illustrated) (S64). At this time, the instruction decoder keeps the interlock of the instruction A LOAD1 after the barrier microinstruction to “1” (S64).

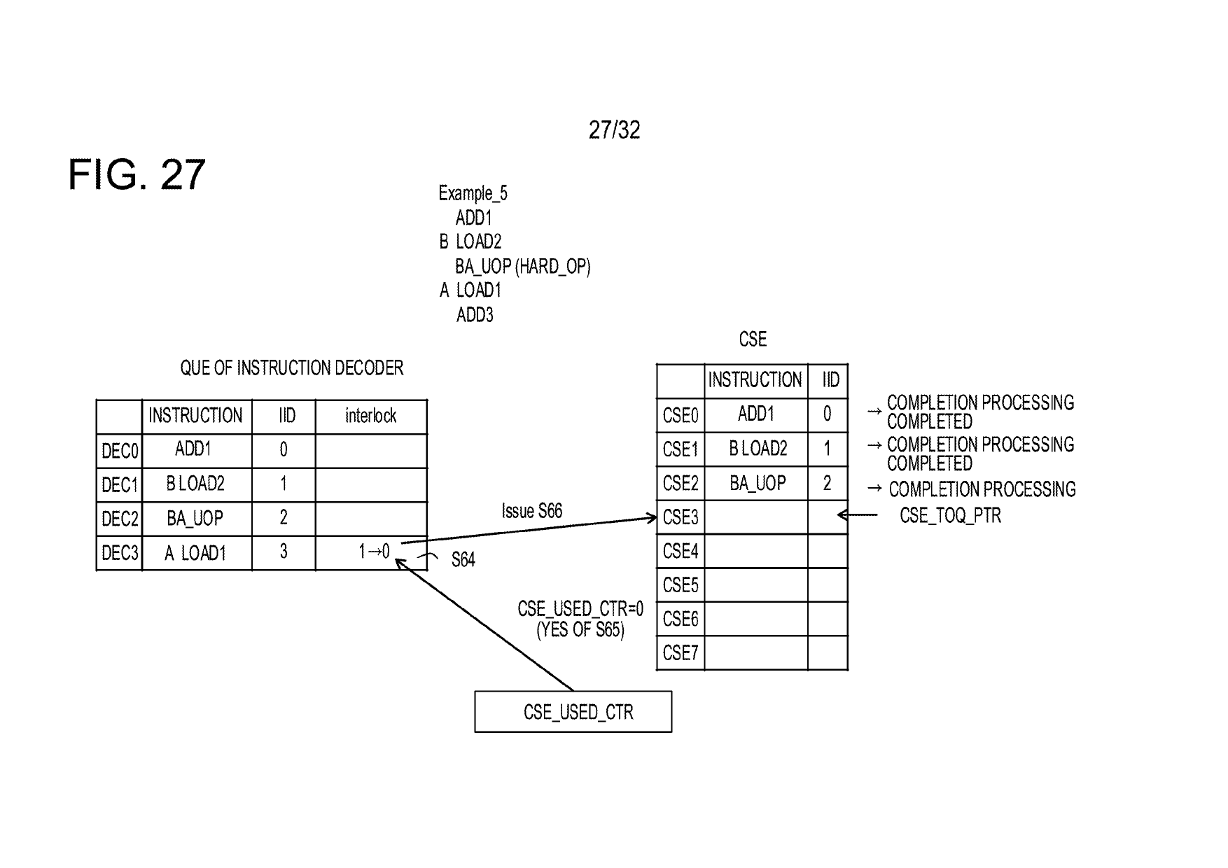

As illustrated in FIG. 27, the CSE performs completion processing of the barrier microinstruction BA_UOP, and the count value of the CSE use counter managed by the instruction decoder becomes “0” based on a completion processing report of the barrier microinstruction from the CSE. Thereby, the instruction decoder detects that the CSE is in the empty state (“YES” in S65). As a result, the instruction decoder releases the interlock of the instruction A LOAD1 after the barrier microinstruction BA_UOP to “0” (S66) and then issues the instruction A LOAD1 to the CSE and the RS (not illustrated) (S66).

As a result, the instruction decoder becomes empty and the next fetch instruction is input in an in-order. Thereafter, in the same manner as above, issuance of an instruction before the barrier microinstruction, detection of the empty state of the CSE, issuance of the barrier microinstruction, detection of the empty state of the CSE, and issuance of an instruction after the barrier microinstruction are repeated.

According to the barrier control described above, the processor complies with the order guarantee that all instructions after a barrier microinstruction of the barrier attributes ABA are not speculatively executed to overtake all instructions before the barrier microinstruction.

In Example_5, since the memory access instruction A_LOAD1 is not executed until the processing of the memory access instruction B LOAD2 is completed, the memory access instruction B LOAD2 is trapped for an address to the privileged area and the secret value in the register X0 is cleared. Thereafter, even when the memory access instruction A LOAD1 is executed, data cannot be registered in a cache line in the L1 data cache with the secret value as an address, and the secret value is unknown.

### Second Embodiment

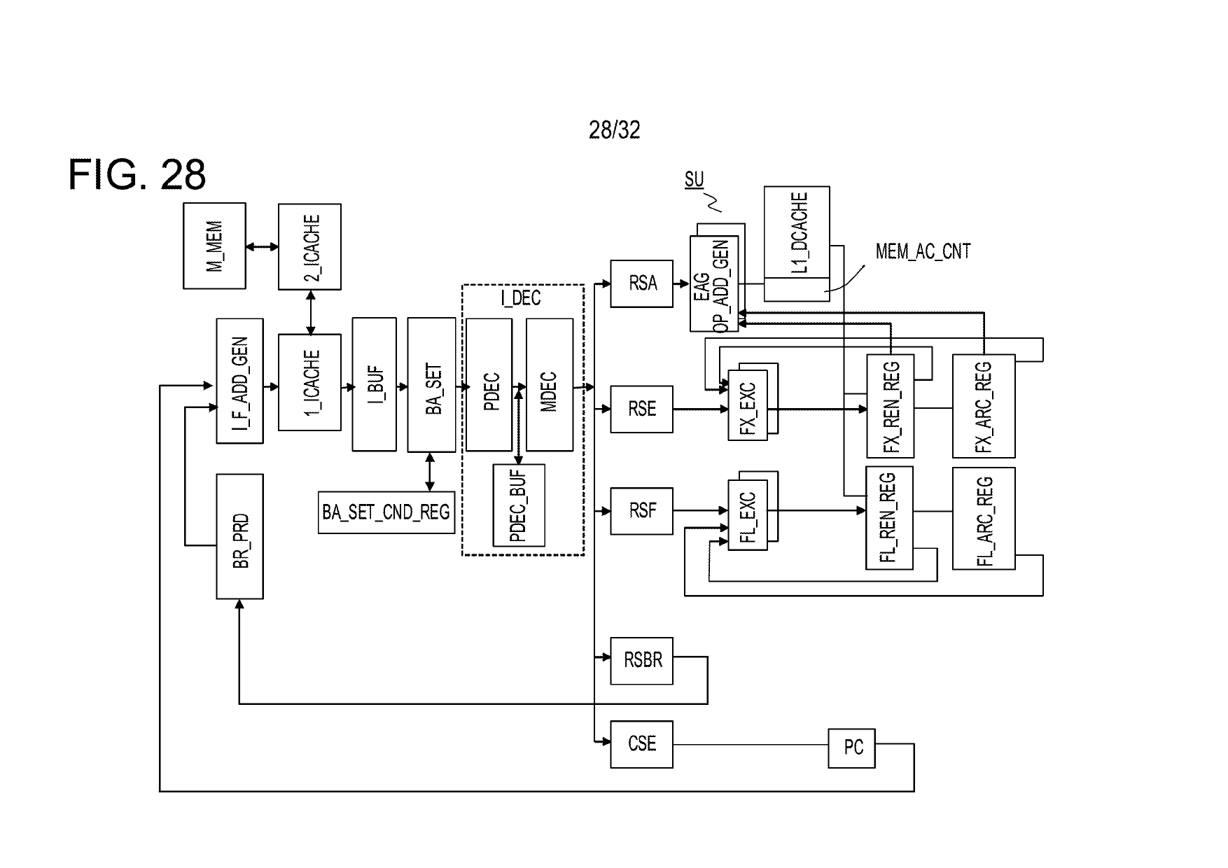

FIG. 28 is a view illustrating an example of a configuration of a processor according to a second embodiment. The configuration of FIG. 28 is different from the configuration of FIG. 2 in that the instruction decoder I_DEC has a two-stage configuration of a pre-decoder PDEC and a main decoder MDEC and further includes a pre-decoder buffer PDEC_BUF for temporarily storing instructions in the pre-decoder PDEC. As will be described later, the pre-decoder PDEC or the pre-decoder buffer PDEC_BUF has a multi-flow instruction dividing circuit that divides a multi-flow instruction into a plurality of microinstructions. Further, the multi-flow instruction dividing circuit divides a barrier attribute-appended fetch instruction into a fetch instruction and a barrier microinstruction.

Each of the pre-decoder PDEC and the main decoder MDEC has N (N is a plural number) slots. In the following example, N=4 and 4 slots are provided. Each slot of the pre-decoder PDEC inputs and holds a multi-flow instruction or a single instruction before division. Meanwhile, each slot of the main decoder MDEC inputs and holds an instruction (division instruction) or a single instruction after division. The pre-decoder buffer PDEC_BUF has N−K (N>K) slots. In the following example, N=4 and K=1, and 3 slots are provided. Each slot of the pre-decoder buffer PDEC_BUF temporarily stores instructions remaining in the pre-decoder PD on the basis of a single instruction or a multi-flow instruction before division.

In the first embodiment, as illustrated in FIG. 3, when the fetch instruction corresponds to the barrier setting condition, the barrier setting circuit appends a barrier attribute corresponding to the corresponding barrier setting condition to the fetch instruction, and adds a barrier microinstruction after the fetch instruction.

In contrast, in the second embodiment, the barrier setting circuit does not add the barrier microinstruction, but the multi-flow instruction dividing circuit in the instruction decoder I_DEC adds the barrier microinstruction to the barrier attribute-appended fetch instruction.

In the second embodiment, the barrier microinstruction is added to all barrier attribute-appended instructions, which leads to an increase in the number of flows. Therefore, the instruction decoder I_DEC has a multi-slot configuration. Specifically, the instruction decoder I_DEC has a two-stage configuration of the pre-decoder PDEC and the main decoder MDEC, and further includes the pre-decoder buffer PDEC_BUF for temporarily storing instructions in the pre-decoder PDEC. As will be described later, the instruction decoder having this configuration efficiently issues a plurality of microinstructions obtained by dividing a fetch instruction or a multi-flow instruction to the RS. Therefore, even when the barrier microinstruction is added to all the barrier attribute-appended instructions, it is possible to suppress a decrease in processing efficiency of the instruction decoder.

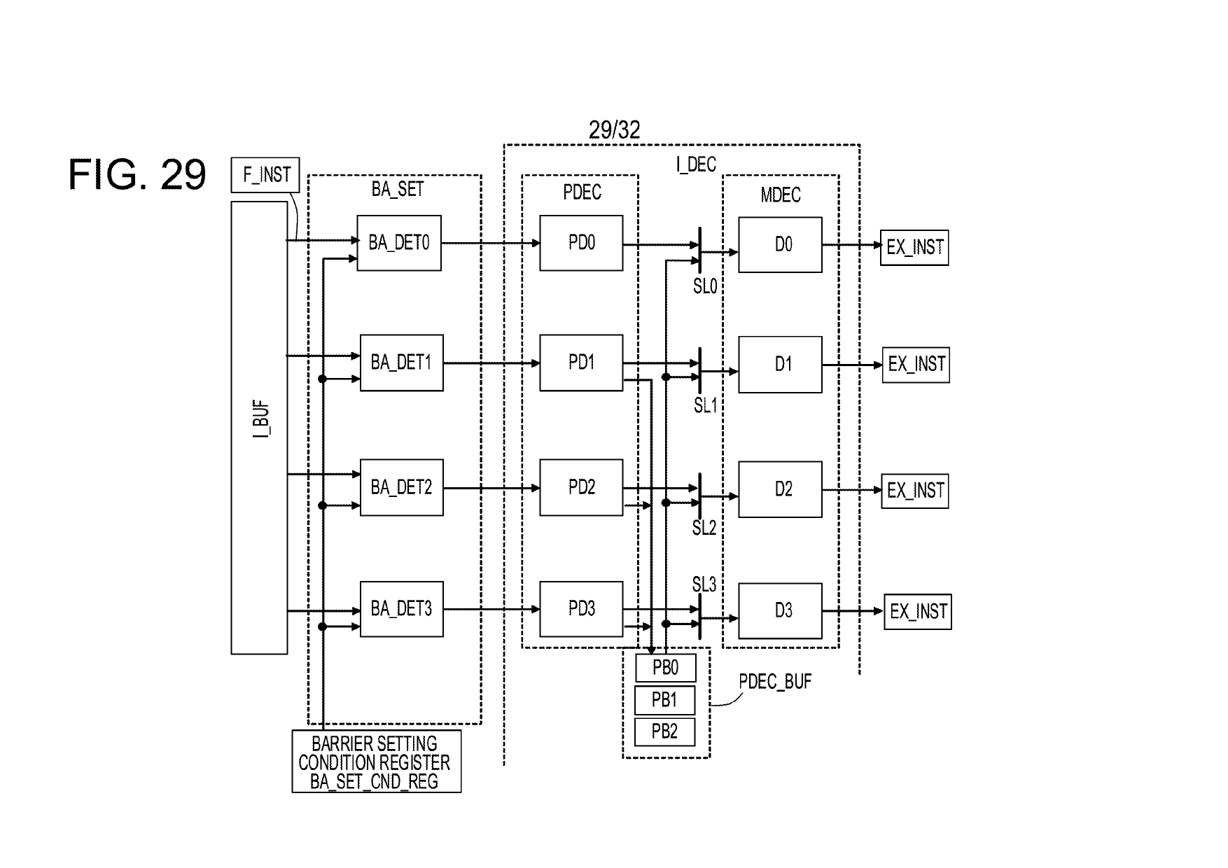

FIG. 29 is a view illustrating a schematic configuration of the barrier setting circuit BA_SET and the instruction decoder I_DEC according to the second embodiment. Similarly to FIG. 3, the barrier setting circuit and the instruction decoder may be combined into a barrier setting/instruction decoder.

Similarly to FIG. 3, the barrier setting circuit BA_SET has barrier determination circuits BA_DET0 to BA_DET3 of four slots and a barrier setting condition register BA_SET_CND_REG referred to by the barrier determination circuits. However, the barrier setting circuit does not have a configuration in which the barrier determination circuits add a barrier microinstruction after a barrier attribute-appended instruction.

Meanwhile, the instruction decoder I_DEC includes a pre-decoder PDEC having pre-decoders PD0 to PD3 of 4 slots, a main decoder MDEC having main decoders D0 to D3 of 4 slots, and a pre-decoder buffer PDEC_BUF having pre-decoder buffers PB0 to PB2 of 3 slots. A fetch instruction in the pre-decoders PD0 to PD3 is shifted to the main decoders D0 to D3 through selectors SL0 to SL3. However, a fetch instruction in the pre-decoders PD1 to PD3 which could not be shifted is shifted to the main decoders D0 to D3 through the selectors SL0 to SL3 via the pre-decoder buffers PB0 to PB2. Meanwhile, four new fetch instructions are latched in the pre-decoders PD0 to PD3.

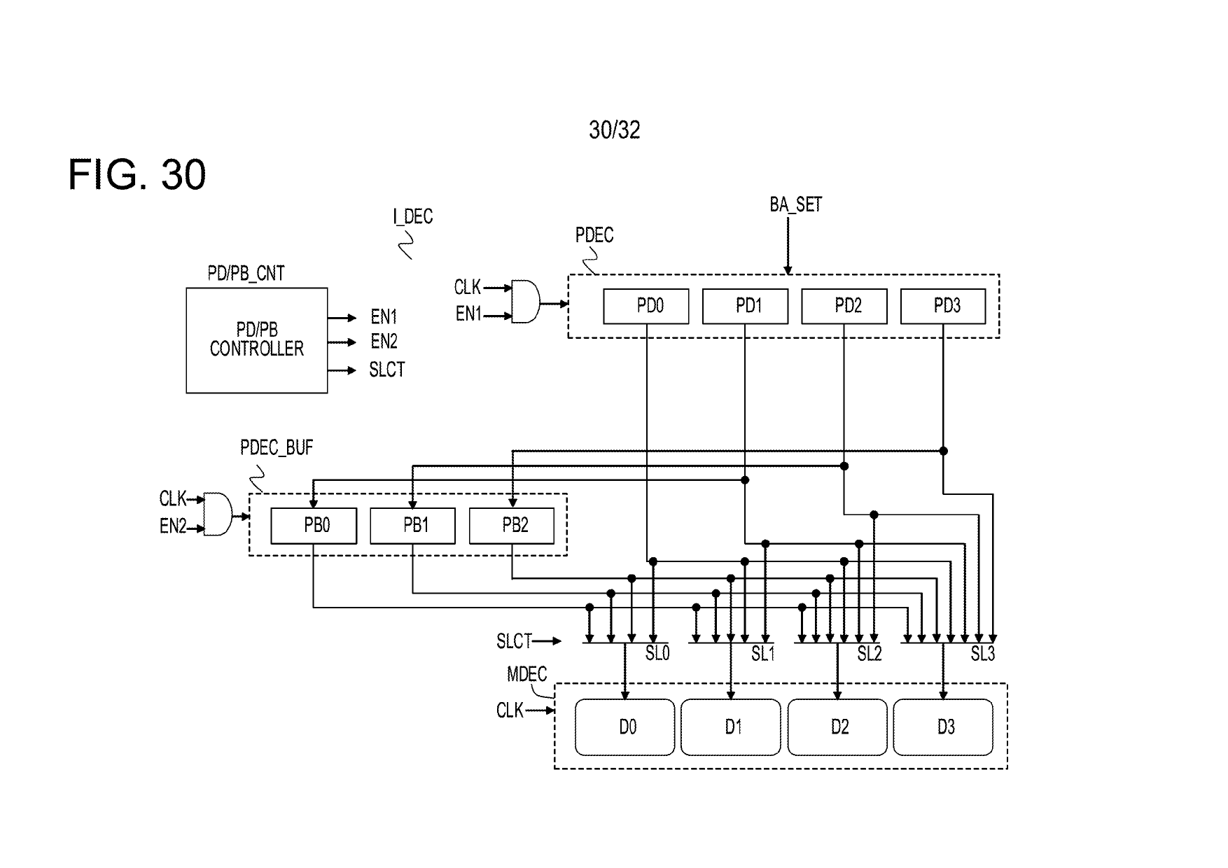

In FIG. 29, a route line directing from the pre-decoder PD0 to the main decoders D0 to D3 and a route line directing from the pre-decoder buffer PDEC_BUF to the main decoders D0 to D3 are partially omitted. Those route lines are clearly illustrated in FIG. 30 below.

FIG. 30 is a view illustrating an example of a configuration of the instruction decoder I_DEC. The pre-decoder PDEC has four slots PD0 to PD3 into which four in-order fetch instructions supplied from the instruction buffer I_BUF are simultaneously entered or input. A control signal that enters the fetch instructions is an AND signal of a clock CLK and a first enable signal EN1.

In principle, the main decoder MDEC has four slots D0 to D3 into which four instructions in four slots of the pre-decoder PDEC are simultaneously entered. When any slot of the pre-decoder issues a division instruction of a multi-flow instruction or a barrier microinstruction of a barrier attribute-appended instruction, the division instruction or the barrier microinstruction is entered into the four slots D0 to D3 in the main decoder as many as possible to fill the division instruction, barrier microinstruction or single instruction within the slots in the order of four slots PD0 to PD3 in the pre-decoder. A control signal for entry of the instructions is the clock CLK. However, when there is no vacancy in the queue in the reservation station, the instructions in the four slots D0 to D3 are not transferred to the reservation station, a pipeline clock is disabled, and the state of the instruction decoder I_DEC is held. In the following description, it is assumed that there is always a vacancy in the queue in the reservation station.

Then, the pre-decoder buffer PDEC_BUF has three slots PB0 to PB2 in which fetch instructions (multi-flow instruction, barrier attribute-appended instruction or single instruction) remaining in the second to fourth slots PD1, PD2 and PD3 in the pre-decoder PDEC are simultaneously entered and temporarily stored. A control signal for entry is the clock CLK and a second enable signal EN2.

Further, the selectors SL0 to SL3 are provided on the input sides of the respective slots D0 to D3 of the main decoder MDEC. Thereby, the division instructions, barrier microinstructions or single instructions in the 3 slots PB0 to PB2 of the pre-decoder buffer and the 4 slots PD0 to PD3 of the pre-decoder are entered in the 4 slots D0 to D3 of the main decoder MDEC four by four instructions in the order of PB0 to PB2 and PD0 to PD3.

A pre-decoder/pre-buffer control circuit PD/PB_CNT generates the first enable signal EN1, the second enable signal EN2, and select signals SLCT0 to SLCT3 of the four selectors SL0 to SL3.

The first enable signal EN1 becomes active “1” when the first slot PD0 in the pre-decoder PDEC becomes empty. When the first enable signal EN1 becomes active “1,” in response to the clock CLK, the four slots PD0 to PD3 input new four fetch instructions.

The second enable signal EN2 becomes active “1” when the pre-decoder buffers PB0 to PB2 and at least the first slot PD0 of the pre-decoder become empty. When the second enable signal EN2 becomes active “1,” in response to the clock CLK, the three slots PB0 to PB2 in the pre-decoder buffer input a multi-flow instruction, a barrier attribute-appended instruction or a single instruction remaining in the three slots PD1 to PD3.

Then, the pre-decoder/pre-buffer control circuit PD/PB_CNT generates the four select signals SLCT0 to SLCT3 such that a division instruction, a barrier microinstruction, and a single instruction are entered from the 3 slots PB0 to PB2 of the pre-decoder buffer and the 4 slots PD0 to PD3 of the pre-decoder into the four slots D0 to D3 of the main decoder MDEC four by four instructions in the order (in-order) of PB0 to PB2 and PD0 to PD3.

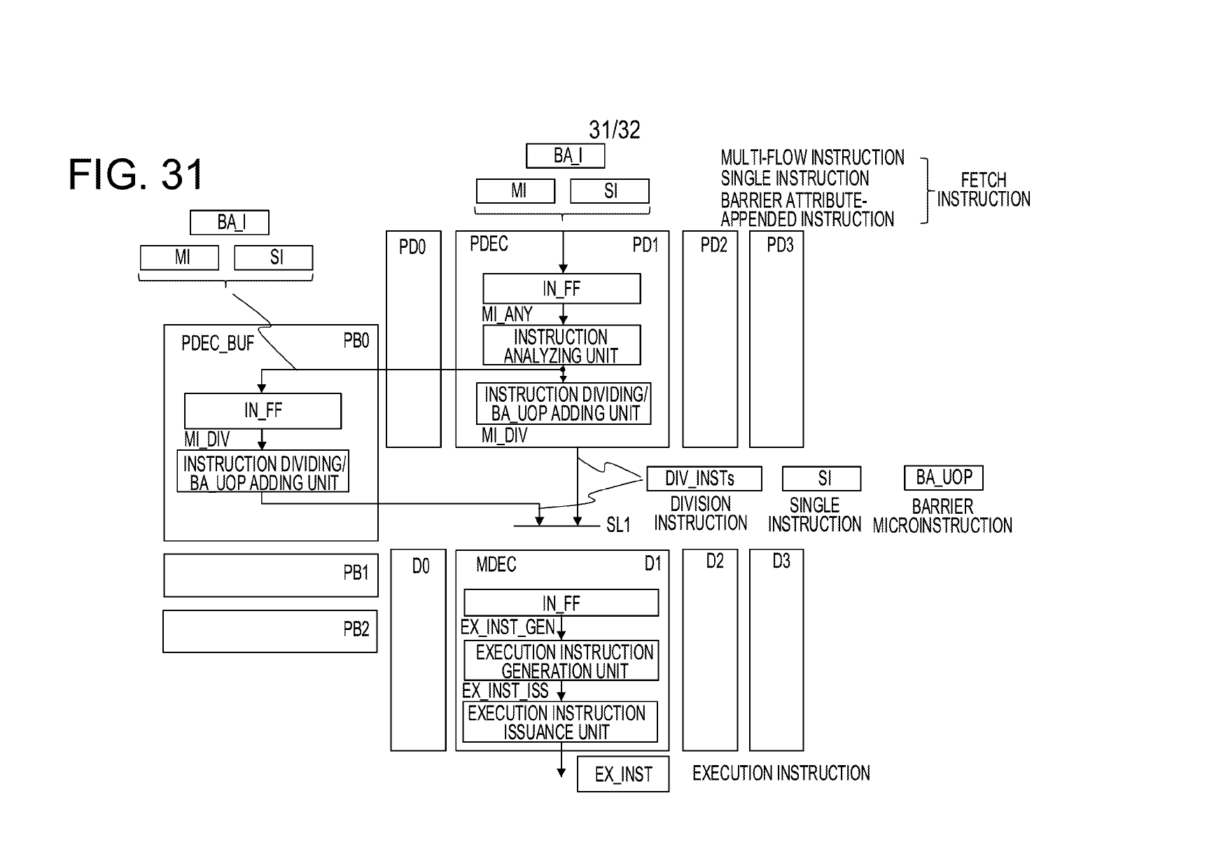

FIG. 31 is a view illustrating an example of a detailed configuration of one slot PD1 of the pre-decoder, one slot PB0 of the pre-decoder buffer, and one slot D1 of the main decoder of the instruction decoder. For example, the slot PD1 in the pre-decoder PDEC has an input latch IN_FF for inputting a fetch instruction from the instruction buffer. The fetch instruction from the instruction buffer includes three types: a multi-flow instruction MI, a single instruction SI, and a barrier attribute-appended instruction.

The slot PD1 further has a multi-flow instruction analyzing circuit MI_ANL which analyzes a multi-flow instruction to detect the number of flows (the number of divisions), and a multi-flow instruction dividing/barrier microinstruction adding circuit MI_DIV which divides the multi-flow instruction based on the analysis result to generate a plurality of flows (division instructions) DIV_INSTs and adds a barrier microinstruction to the barrier attribute-appended instruction. The other slots PD0, PD2, and PD3 have the same configuration.

The slot PB0 of the pre-decoder buffer PDEC_BUF has an input latch IN_FF supplied with the single instruction SI, the multi-flow instruction MI, the barrier attribute-appended instruction, the analysis information thereof, and the number of remaining flows from the slot PD1 of the pre-decoder. The slot PB0 further has a multi-flow instruction dividing circuit MI_DIV which divides the multi-flow instruction based on the multi-flow instruction and the number of remaining flows to generate a plurality of flows (a plurality of division instructions and a plurality of microinstructions) DIV_INSTs and adds a barrier microinstruction BA_UOP to the barrier attribute-appended instruction. The other slots PB0 and PB2 have the same configuration.

Meanwhile, one slot D1 of the main decoder has an input latch IN_FF supplied with the division instruction DIV_INSTs, the single instruction SI, and the barrier microinstruction BA_UOP from the pre-decoder PDEC or the pre-decoder buffer PDEC_BUF. The slot D1 further has an execution instruction generation circuit EX_INST_GEN that decodes the division instruction, the single instruction, and the barrier microinstruction BA_UOP to generate an execution instruction (execution instruction) EX_INST of an executable format, and an execution instruction issuance circuit EX_INST_ISS that issues an execution instruction EX_INST.

The fetch instruction input to the instruction decoder is an operation code of an instruction. Meanwhile, the execution instruction generated by the instruction decoder is an instruction including a decoding result for making an operation code of the fetched instruction executable. For example, it is an instruction including information necessary for an arithmetic operation, such as which reservation station is used, which arithmetic circuit is used, and which data is used for an operand. The execution instruction generation circuit EX_INST_GEN decodes the fetched instruction operation code to obtain information necessary for arithmetic execution and generate an execution instruction.

As illustrated in FIG. 31, the slot PD0 in the pre-decoder PDEC may output an instruction to the four slots D0 to D3 in the main decoder MDEC, the slot PD1 may output an instruction to the three slots D1 to D3, the slot PD2 may output an instruction to the two slots D2 and D3, and the slot PD3 may output an instruction to the slot D3. Meanwhile, the three slots PB0 to PB2 of the pre-decoder buffer PDEC_BUF may output an instruction to any of the four slots D0 to D3 of the main decoder.

With such a configuration, the four single instructions supplied to the four slots PD0 to PD3 of the pre-decoder PDEC are simultaneously transmitted to the four slots D0 to D3 of the main decoder MDEC when there is no instruction in the pre-buffers PB0 to PB2. Meanwhile, when a multi-flow instruction is supplied to the head slot PD0 of the pre-decoder PDEC, a plurality of division instructions generated by dividing the multi-flow instruction are transmitted in-order to the four slots D0 to D3 of the main decoder MDEC. Further, when a barrier attribute-appended instruction is supplied to the slot PD0, the barrier attribute-appended instruction and a barrier microinstruction added after the barrier attribute-appended instruction are transmitted in-order to the slots D0 and D1 of the main decoder. Further, the division instruction, the single instruction, and the barrier attribute-appended instruction of the three slots PD1 to PD3 of the pre-decoder are transmitted to one of the three slots D1 to D3 at the same time when the division instruction, the single instruction, and the barrier microinstruction of the head slot PD0 are transmitted to the head slot D0 of the main decoder. Furthermore, the single instruction, the division instruction of the multi-flow instruction, and the barrier microinstruction of the three slots PB0 to PB2 of the pre-decoder buffer PDEC_BUF may be transmitted to any of the slots D0 to D3 of the main decoder.

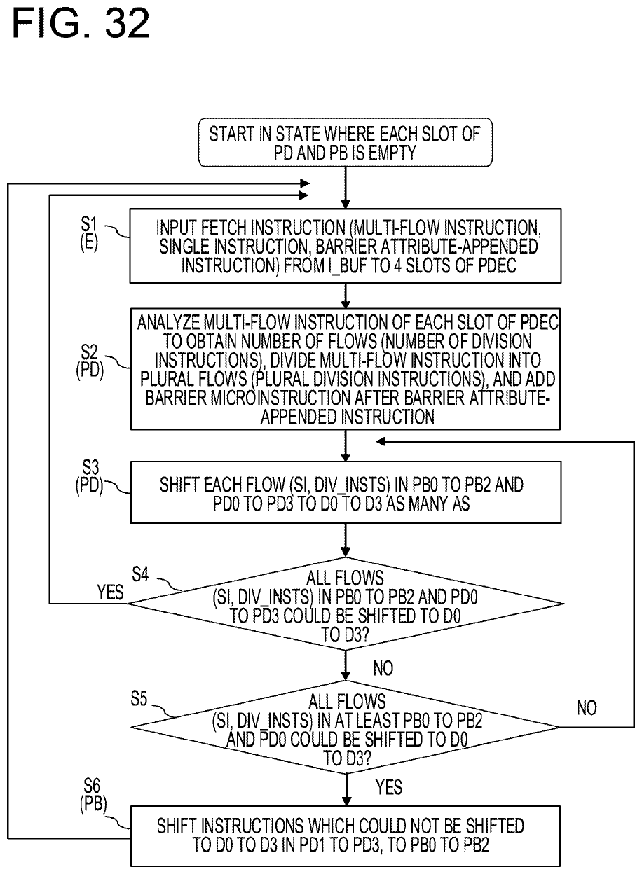

FIG. 32 is a flowchart illustrating the operation of the pre-decoder and the pre-decoder buffer in the instruction decoder. First, when the instruction decoder I_DEC starts processing a fetch instruction, there is no instruction in each slot of the pre-decoder PDEC and the pre-decoder buffer PDEC_BUF.

Therefore, the single instruction SI, the multi-flow instruction MI or the barrier attribute-appended instruction is supplied in-order from the instruction buffer I_BUF to the four slots PD0 to PD3 of the pre-buffer in the order of PD0 to PD3, and is latched in the input latch IN_FF in each of the slots PD0 to PD3 (S1).

Next, when the four slots are supplied with multi-flow instructions, the instruction analysis circuit MI_ANL of each slot analyzes each multi-flow instruction to detect the number of flows (the number of division instructions) (S2). Similarly, when the four slots are supplied with barrier attribute-appended instructions, the instruction analysis circuit MI_ANL of each slot analyzes each barrier attribute multi-flow instruction to detect the number of flows (the number of barrier microinstructions) (S2). Further, the instruction dividing/barrier microinstruction adding circuit MI_DIV of each slot divides each multi-flow instruction to generate a division instruction DIV_INSTs (S2). Similarly, a barrier microinstruction is additionally generated after each barrier attribute instruction (S2).

Then, the instruction decoder divides the single instruction SI, the division instruction DIV_INSTs or the barrier microinstruction BA_UOP in the three slots PB0 to PB2 in the pre-decoder buffer PDEC_BUF and the four slots PD0 to PD3 in the pre-decoder PDEC in the order of PB0 to PB2 and PD0 to PD3, and then stores these instructions as many as possible to fill the four slots D0 to D3 in the main decoder MDEC on the basis of the number of flows (the number of single instructions SI, division instructions DIV_INSTs and barrier microinstructions) (S3). These instructions are shifted to the four slots D0 to D3 of the main decoder as many as the total number of division instructions in the four slots PD0 to PD3.

When all the flows (single instruction SI, division instruction DIV_INSTs, and barrier microinstruction) in the slots PB0 to PB2 and PD0 to PD3 in the pre-decoder buffer and the pre-decoder could be shifted to the slots D0 to D3 in the main decoder (“YES” in S4), the instruction decoder inputs four new fetch instructions from the instruction buffer I_BUF to the four slots PD0 to PD3 of the pre-decoder (S1).

In the first time, since no instruction is stored in the slots PB0 to PB2, the determination of S4 is a determination as to whether or not all the flows in the four slots PD0 to PD3 could be shifted to the slots D0 to D3 in the main decoder. In the first case, when four single instructions SI are input into the four slots PD0 to PD3, all the instructions may be shifted to the four slots D0 to D3 of the main decoder. When a multi-flow instruction or a barrier attribute-appended instruction is input into any of the four slots PD0 to PD3, since the number thereof is 5 or more on the basis of the number of flows after division, the result of the determination of S4 is NO. The number of flows is the number of microinstructions, specifically, the number of single instructions, the number of division instructions, or the number of barrier microinstructions.

When none of the flows in the slots PB0 to PB2 and PD0 to PD3 could be shifted to the slots D0 to D3 in the main decoder (“NO” in S4), and when none of the flows (SI or DIV_INSTs) in at least the slots PB0 to PB2 and PD0 could be shifted to the four slots D0 to D3 of the main decoder (“NO” in S5), the steps S3 and S4 are repeated again.

Meanwhile, even when none of the flows in the slots PB0 to PB2 and PD0 to PD3 could be shifted to the four slots in the main decoder (“NO” in S4), when all of the flows (SI or DIV_INSTs) in at least the slots PB0 to PB2 and PD0 could be shifted to the four slots D0 to D3 of the main decoder (“YES” in S5), the three slots PD1, PD2, and PD3 of the pre-decoder shift the remaining instructions, which could not be shifted to D0 to D3 of the main buffer, to the three slots PB0 to PB2 of the pre-decoder buffer PDEC_BUF in the order of PB0, PB1, and PB2 (S6). The remaining instructions which could not be shifted to D0 to D3 of the main buffer are single instructions SI, multi-flow instructions MI or barrier attribute-appended instructions, and the number of remaining flows and the MI analysis information are also shifted in addition to the multi-flow instructions MI or the barrier attribute-appended instructions.

Then, referring back to the first step S1, the four slots PD0 to PD3 of the pre-decoder PDEC input new four fetch instructions in-order from the instruction buffer I_BUF (S1).

As described above, the four fetch instructions (single instruction SI, multi-flow instruction MI or barrier attribute-appended instruction) are simultaneously input to the four slots PD0 to PD3 of the pre-decoder PDEC. Then, the multi-flow instruction is divided in the pre-decoder slots PD0 to PD3 or a barrier microinstruction is added to the barrier attribute-appended instruction, and the single instruction SI, the division instruction DIV_ISNTs or the barrier microinstruction is shifted from the pre-decoder slots PD0 to PD3 to the main decoder slots D0 to D3. When at least the instructions in the head slot PD0 of the pre-decoder are all shifted to the main decoder, the fetch instructions remaining in the pre-decoder are temporarily shifted to the three slots PB0 to PB2 of the pre-decoder buffer, and at the same time, new four fetch instructions are input from the instruction buffer I_BUF. After that, the single instructions or division instructions in the three slots PB0 to PB2 of the pre-decoder buffer and the four slots PD0 to PD3 of the pre-decoder are shifted to the four slots D0 to D3 of the main decoder four by four flows (instructions).

As illustrated in FIG. 32, the instruction decoder I_DEC is composed of the pre-decoder PDEC for analyzing and dividing a multi-flow instruction, and the main decoder MDEC for decoding a single instruction, a division instruction or a barrier microinstruction to generate an execution instruction. When the multi-flow instruction is divided into a plurality of division instructions or a barrier microinstruction is added to the barrier attribute-appended instruction and none of the instructions in the pre-decoder may be shifted to the main decoder and when at least the head slot PD0 in the pre-decoder has no instruction, the remaining instructions in the pre-decoders PD1 to PD3 are temporarily shifted to the three slots PB0 to PB2 of the pre-decoder buffer, and new four fetch instructions are input into the four slots of the pre-decoder. With such a configuration, even when a multi-flow instruction or a barrier attribute-appended instruction is inserted in a fetch instruction, since the instruction decoder issues four execution instructions in each cycle, it is possible to suppress a reduction in throughput of the instruction decoder I_DEC.

<Example of Setting in Barrier Setting Condition Register>

In the present embodiment, in order to prevent the memory access instruction described first with reference to FIG. 1 from being speculatively executed, the barrier setting condition is set in the barrier setting condition register. For example, as in the first example illustrated in FIG. 1, when it is desired to prevent a memory access instruction of a branch prediction destination from being speculatively executed before a branch instruction is determined to branch, the barrier setting condition register is set so that the barrier attribute BBM is appended to a branch instruction in the privileged mode as the barrier setting condition. In addition, when it is desired to prevent the two load instructions described after the second example from being speculatively executed, the barrier setting condition register is set so that the barrier attribute MBM is appended to a memory access instruction in the privileged mode as the barrier setting condition. When it is desired to prevent other instructions from being speculatively executed, the barrier setting condition register is set so that the barrier attribute ABM or ABA is appended to an instruction in the privileged mode as the barrier setting condition.

Since the security vulnerability of the processor varies depending on users, it is desirable that each user selects a necessary barrier attribute and sets the barrier setting condition.

In either case, for example, in an initialization process in which a user executes an application, a desired barrier setting condition is set in the barrier setting condition register or a barrier setting condition is set in the barrier condition register at a specific timing of the application.

As described above, according to the present embodiment, by setting the barrier setting condition in the barrier setting register to cope with the cause of the security vulnerability of a processor of a user, it is possible to perform a barrier control to implement the order guarantee of instruction execution in the RSA, the memory access control circuit, and the memory decoder. As a result, it is possible to prevent the processor from speculatively executing an instruction.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to an illustrating of the superiority and inferiority of the invention. Although the embodiments of the present invention have been described in detail, it should be understood that the various changes, substitutions, and alterations could be made hereto without departing from the spirit and scope of the invention.

What is claimed is:

1. An arithmetic processing apparatus comprising:
a memory; and
a processor coupled to the memory and configured to:
set a barrier setting condition in a barrier setting condition register, determine whether or not a fetch instruction satisfies the barrier setting condition set in the barrier setting condition register,
when the fetch instruction satisfies the barrier setting condition, add a barrier microinstruction to be subjected to barrier control of a barrier attribute corresponding to the corresponding barrier setting condition after the corresponding fetch instruction,
generate an execution instruction by decoding the fetch instruction,
allocate the execution instruction and the barrier microinstruction to respective execution queue circuits,
when a memory access instruction which is one type of the execution instruction and the barrier microinstruction in an out-of-order different from the order of programs are input, execute the memory access instruction and the barrier microinstruction, and
when the barrier microinstruction is input, perform a control so that a memory access instruction after the barrier microinstruction is not speculatively executed to overtake a predetermined execution instruction corresponding to the barrier attribute before the barrier microinstruction.

2. The arithmetic processing apparatus according to claim 1,
wherein the barrier attribute has an attribute of branch instruction versus memory access instruction, and
the processor is configured to:
add the barrier microinstruction after the fetch instruction corresponding to the barrier attribute of branch instruction versus memory access instruction, and
perform a control so that the memory access instruction after the barrier microinstruction is executed after the processing of a branch instruction before the barrier microinstruction is completed.

3. The arithmetic processing apparatus according to claim 2,
wherein the processor is configured to issue the memory access instruction after the barrier microinstruction after the processing of the branch instruction before the barrier microinstruction is completed.

4. The arithmetic processing apparatus according to claim 1,
wherein the barrier attribute has an attribute of memory access instruction versus memory access instruction, and
the processor is configured to:
add the barrier microinstruction after the fetch instruction corresponding to the barrier attribute of memory access instruction versus memory access instruction, and
perform a control so that a memory access instruction after the barrier microinstruction is executed after the processing of the memory access instruction before the barrier microinstruction is completed.

5. The arithmetic processing apparatus according to claim 4,
wherein when the memory access instruction after the barrier microinstruction is input, and
the processor is configured to:
execute the barrier microinstruction after the processing of the memory access instruction before the barrier microinstruction is completed, and
execute the memory access instruction after the barrier microinstruction after the processing of the barrier microinstruction is completed.

6. The arithmetic processing apparatus according to claim 1,
wherein the barrier attribute has an attribute of all instructions versus memory access instruction, and
the processor is configured to, when the barrier microinstruction after the fetch instruction corresponding to the barrier attribute of all instructions versus memory access instruction is input, perform a control so that the memory access instruction after the barrier microinstruction is executed after the processing of all instructions before the barrier microinstruction is completed.

7. The arithmetic processing apparatus according to claim 6,
wherein the processor is configured to:
when an instruction issued in an in-order, complete the processing of the instruction in an in-order, and
when the memory access instruction after the barrier microinstruction is input, execute the barrier microinstruction after the processing of all instructions before the barrier microinstruction is completed, and execute the memory access instruction after the barrier microinstruction after the processing of the barrier microinstruction is completed.

8. The arithmetic processing apparatus according to claim 1,
wherein the barrier attribute has an attribute of all instructions versus all instructions, and the processor is configured to:
when an instruction issued in an in-order, complete the processing of the instruction in an in-order, and
when the barrier microinstruction after the fetch instruction corresponding to the barrier attribute of all instructions versus all instructions is input, based on a completion of the processing, issue all instructions after the barrier microinstruction after the processing of all instructions before the barrier microinstruction is completed.

9. The arithmetic processing apparatus according to claim 8,
wherein the processor is configured to:
when the barrier microinstruction is input, based on a completion of the processing, issue the barrier microinstruction after the processing of all instructions before the barrier microinstruction is completed, and
issue all instructions after the barrier microinstruction after the processing of the barrier microinstruction is completed.

10. The arithmetic processing apparatus according to claim 1, wherein the processor is configured to,
when the fetch instruction is a multi-flow instruction, divide the multi-flow instruction into a plurality of micro instructions, and
add the barrier microinstruction after the fetch instruction corresponding to the barrier setting condition.

11. The arithmetic processing apparatus according to claim 1, wherein the processor is configured to:
speculatively execute a memory access instruction after the barrier microinstruction at a stage where a branch destination of the branch instruction before the barrier microinstruction is not determined; and
speculatively execute a memory access instruction after the barrier microinstruction at a stage where it is determined whether or not the memory access instruction is an access to an access prohibited area in a memory and a process of trapping and cancelling the memory access instruction when it is determined that the memory access instruction is an access to the access prohibited area is not completed.

12. The arithmetic processing apparatus according to claim 1, wherein the predetermined execution instruction corresponding to the barrier attribute is one of a branch instruction, a memory access instruction and all instructions, which is designated with the barrier attribute.

13. An arithmetic processing method executed by a processor included in an arithmetic processing apparatus, the method comprising:
setting a barrier setting condition in a barrier setting condition register,
determining whether or not a fetch instruction satisfies the barrier setting condition set in the barrier setting condition register,
when the fetch instruction satisfies the barrier setting condition, adding a barrier microinstruction to be subjected to barrier control of a barrier attribute corresponding to the corresponding barrier setting condition after the corresponding fetch instruction,
generating an execution instruction by decoding the fetch instruction,
allocating the execution instruction and the barrier microinstruction to respective execution queue circuits,
when a memory access instruction which is one type of the execution instruction and the barrier microinstruction in an out-of-order different from the order of programs are input, executing the memory access instruction and the barrier microinstruction, and
when the barrier microinstruction is input, performing a control so that a memory access instruction after the barrier microinstruction is not speculatively executed to overtake a predetermined execution instruction corresponding to the barrier attribute before the barrier microinstruction.
